(19) United States
(12) Patent Application Publication
(10) Pub. No.: US 2025/0380078 A1
(43) Pub. Date: Dec. 11, 2025

(54) SPEAKER ASSEMBLIES AND EARPHONES

(71) Applicant: SHENZHEN SHOKZ CO., LTD., Shenzhen (CN)

(72) Inventors: Junjiang FU, Shenzhen (CN); Yueqiang WANG, Shenzhen (CN); Song YOU, Shenzhen (CN)

(73) Assignee: SHENZHEN SHOKZ CO., LTD., Shenzhen (CN)

(21) Appl. No.: 19/309,566

(22) Filed: Aug. 25, 2025

Related U.S. Application Data
(63) Continuation of application No. PCT/CN2024/076071, filed on Feb. 5, 2024.

(51) Int. Cl. H04R 1/10; H04R 1/24; H04R 9/02; H04R 9/06

(52) U.S. Cl. CPC H04R 1/1008; H04R 1/1075; H04R 1/24; H04R 9/025; H04R 9/06; H04R 2460/13

(57) ABSTRACT

Speaker assemblies and earphones are provided. The speaker assembly includes a bone conduction speaker. The bone conduction speaker includes a transducer, and the transducer includes a clamp and a magnetic circuit system. The magnetic circuit system includes at least two annular magnets. The at least two annular magnets are stacked along an axial direction of the magnetic circuit system, and adjacent annular magnets in the at least two annular magnets are arranged to repel each other along the axial direction. The clamp is configured to clamp two outer end surfaces of the magnetic circuit system away from each other along the axial direction.

### CROSS-REFERENCE TO RELATED APPLICATION

The application is a Continuation of International Application No. PCT/CN2024/076071 filed on Feb. 5, 2024, the contents of which are entirely incorporated herein by reference.

### TECHNICAL FIELD

The application relates to the technical field of electronic devices, and in particular, to speaker assemblies and earphones.

### BACKGROUND

With the increasing proliferation of electronic devices, the electronic devices have become indispensable social and entertainment tools in people's daily lives, and people's requirements for the electronic devices are also increasing. The electronic devices (e.g., earphones, smart glasses) have also been widely used in people's daily life, which can be used in conjunction with terminal devices (e.g., mobile phones, computers, etc.) to provide users with an auditory feast.

### SUMMARY

The present disclosure provides a speaker assembly including a bone conduction speaker. The bone conduction speaker includes a transducer, and the transducer includes a clamp and a magnetic circuit system. The magnetic circuit system includes at least two annular magnets, the at least two annular magnets are stacked along an axial direction of the magnetic circuit system, and adjacent annular magnets in the at least two annular magnets are arranged to repel each other along the axial direction; and the clamp is configured to clamp two outer end surfaces of the magnetic circuit system away from each other along the axial direction.

In some embodiments, the clamp includes a first abutment portion, a second abutment portion, and a connection portion, the first abutment portion abuts against one of the two outer end surfaces of the magnetic circuit system, the second abutment portion abuts against the other one of the two outer end surfaces of the magnetic circuit system, and the connection portion is connected between the first abutment portion and the second abutment portion.

In some embodiments, the first abutment portion, the second abutment portion, and the connection portion are formed by bending a plate and are disposed in a U-shape.

In some embodiments, the transducer further includes a support, a coil, and a vibration transmission sheet, the vibration transmission sheet connects the magnetic circuit system and the support to elastically suspend the magnetic circuit system at a periphery of the support, the coil is disposed on the support and located within the magnetic circuit system, and the connection portion is disposed on an outer side of the magnetic circuit system.

In some embodiments, the vibration transmission sheet includes an inner annular fixing portion, an outer annular fixing portion, and at least two elastic connection portions, the outer annular fixing portion is disposed at a periphery of the inner annular fixing portion, the at least two elastic connection portions are connected between the inner annular fixing portion and the outer annular fixing portion, the inner annular fixing portion is connected to the support, the outer annular fixing portion is connected to at least one of the two outer end surfaces of the magnetic circuit system, the outer annular fixing portion is provided with at least one notch, the at least one of the two outer end surfaces of the magnetic circuit system being exposed from the at least one notch, and the first abutment portion and/or the second abutment portion are disposed to abut against an exposed portion of the at least one of the two outer end surfaces of the magnetic circuit system exposed from the at least one notch.

In some embodiments, the at least one notch includes at least two notches, the at least two notches are disposed at intervals along a circumferential direction of the outer annular fixing portion, each of the at least two notches is connected to an outer edge of the outer annular fixing portion, and along the circumferential direction of the outer annular fixing portion, a ratio of a total width of the at least two notches on the outer edge of the outer annular fixing portion to a circumference of the outer edge of the outer annular fixing portion is smaller than or within a range from 0.08 to 0.25.

In some embodiments, the transducer further includes a magnetic conduction cover. The magnetic conduction cover is arranged in a cylindrical shape and connected to the support, the coil is wound at a periphery of the magnetic conduction cover, the inner annular fixing portion is connected to an outer end surface of the magnetic conduction cover, and the vibration transmission sheet is a magnetic conductor.

In some embodiments, the inner annular fixing portion is welded and fixed to the outer end surface of the magnetic conduction cover, and the outer annular fixing portion is welded and fixed to the at least one of the two outer end surfaces of the magnetic circuit system.

In some embodiments, the clamp is a non-magnetic body.

In some embodiments, the clamp includes at least two clamps, and the at least two clamps are disposed at intervals along a circumferential direction of the magnetic circuit system.

The present disclosure provides an earphone. The earphone includes the speaker assembly as described in the above embodiments and a wearing assembly connected to the speaker assembly. The wearing assembly is configured to position the speaker assembly at a facial region anterior to a user's tragus in a wearing state.

The present disclosure brings the following beneficial effect. Different from conventional solutions, the present disclosure provides the clamp configured to clamp on the two outer end surfaces of the magnetic circuit system away from each other. This can restrict a relative displacement between the at least two annular magnets, thereby reducing the likelihood of loosening and preventing failure of the transducer's conversion function. As a result, a structural stability, a tightness, a reliability, and a service life of the transducer can be enhanced.

### BRIEF DESCRIPTION OF THE DRAWINGS

In order to more clearly illustrate the technical solutions in the embodiments of the present disclosure or the prior art, the following will briefly introduce the drawings that need to be used in the description of the embodiments or the prior art. Obviously, the accompanying drawings in the following description are merely some embodiments of the present disclosure. For those of ordinary skill in the art, other drawings may also be obtained according to these drawings without creative work.

FIG. 1 is a schematic diagram illustrating a three-dimensional structure of an earphone according to some embodiments of the present disclosure;

FIG. 2 is a schematic diagram illustrating a disassembled structure of the earphone as shown in FIG. 1;

FIG. 3 is a schematic diagram illustrating an application scenario of the earphone as shown in FIG. 1;

FIG. 4 is a schematic diagram illustrating a disassembled structure of a bone conduction speaker as shown in FIG. 2;

FIG. 5 is a top view of a first vibration transmission sheet of the bone conduction speaker as shown in FIG. 2;

FIG. 6 is a top view of a first vibration transmission sheet of the bone conduction speaker not shown in FIG. 2;

FIG. 7 is a sectional view of a cross-section Z-Z as shown in FIG. 1;

FIG. 8 is a schematic diagram illustrating a three-dimensional structure of a core housing as shown in FIG. 4;

FIG. 9 is a bottom view of a portion of a structure of a transducer as shown in FIG. 4;

FIG. 10 is a schematic diagram illustrating another disassembling structure of the bone conduction speaker as shown in FIG. 2;

FIG. 11 is a schematic diagram illustrating a portion of a disassembling structure of a transducer as shown in FIG. 10;

FIG. 12 is a bottom view of a portion of a structure of the transducer as shown in FIG. 10;

FIG. 13 is a top view of a vibration plate of the bone conduction speaker not shown in FIG. 2;

FIG. 14 is a schematic diagram illustrating a three-dimensional structure of a vibration plate as shown in FIG. 10;

FIG. 15 is a schematic diagram illustrating another disassembling structure of the bone conduction speaker as shown in FIG. 2;

FIG. 16 is a bottom view of the bone conduction speaker as shown in FIG. 2;

FIG. 17 is a schematic diagram illustrating an overall structure of a transducer according to the present disclosure;

FIG. 18 is a schematic diagram illustrating a disassembling structure of a portion of assemblies of the transducer according to the embodiment shown in FIG. 17;

FIG. 19 is a schematic diagram illustrating a sectional structure of the transducer shown in FIG. 17 along a sectional direction a-a;

FIG. 20 is a top view of the transducer as shown in FIG. 17;

FIG. 21 is a schematic diagram comparing a circumference of an outer edge of an outer annular fixing portion and a total width of a notch on the outer edge of the outer annular fixing portion of the transducer as shown in FIG. 20;

FIG. 22 is a schematic diagram illustrating a cross-sectional structure of the transducer as shown in FIG. 17 along the sectional direction a-a from another perspective;

FIG. 23 is a schematic diagram illustrating an enlarged structure of a region I of the transducer as shown in FIG. 19;

FIG. 24 is a schematic diagram illustrating an overall structure of a portion of assemblies of the bone conduction speaker of the earphone as shown in FIG. 2;

FIG. 25 is a schematic diagram illustrating a sectional structure of the bone conduction speaker along a sectional direction b-b as shown in FIG. 24;

FIG. 26 is a schematic diagram illustrating a structure of a first vibration transmission sheet of the bone conduction speaker as shown in FIG. 24;

FIG. 27 is a schematic diagram illustrating a disassembled structure of the portion of the assemblies of the bone conduction speaker as shown in FIG. 24;

FIG. 28 is a schematic diagram illustrating a structure of a second vibration transmission sheet of the transducer as shown in FIG. 17; and

FIG. 29 is a schematic diagram illustrating another structure of the second vibration transmission sheet of the transducer as shown in FIG. 17.

### DETAILED DESCRIPTION

The following will clearly and completely describe the technical solutions in the embodiments of the present disclosure with reference to the accompanying drawings in the embodiments of the present disclosure. Obviously, the described embodiments are only a part of the embodiments of the present disclosure, and not all of them. Based on the embodiments of the present disclosure, all other embodiments obtained by persons of ordinary skill in the art without making creative efforts belong to the scope of protection of the present disclosure.

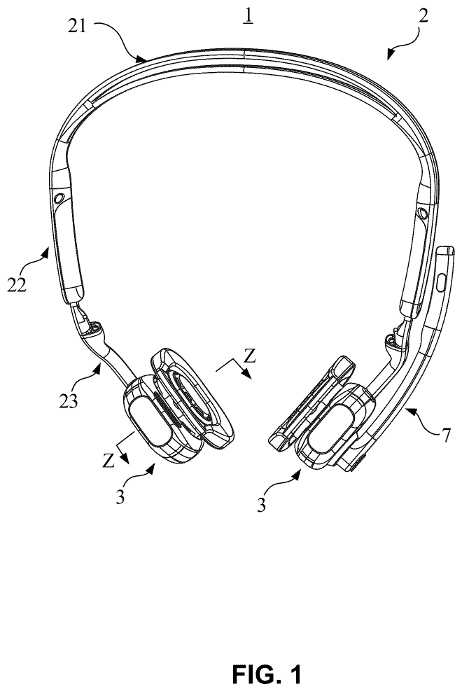

As shown in FIG. 1, an earphone 1 may include a wearing assembly 2, a speaker assembly 3, and a stick microphone assembly 7. A count of the speaker assembly 3 may be two. The two speaker assemblies 3 may be configured to transmit vibrations and/or sounds to a user's left ear and right ear, respectively. The two speaker assemblies 3 may be the same or different. For example, one of the two speaker assemblies 3 may be provided with the stick microphone assembly 7, and the other one of the two speaker assemblies 3 may not be provided with the stick microphone assembly 7.

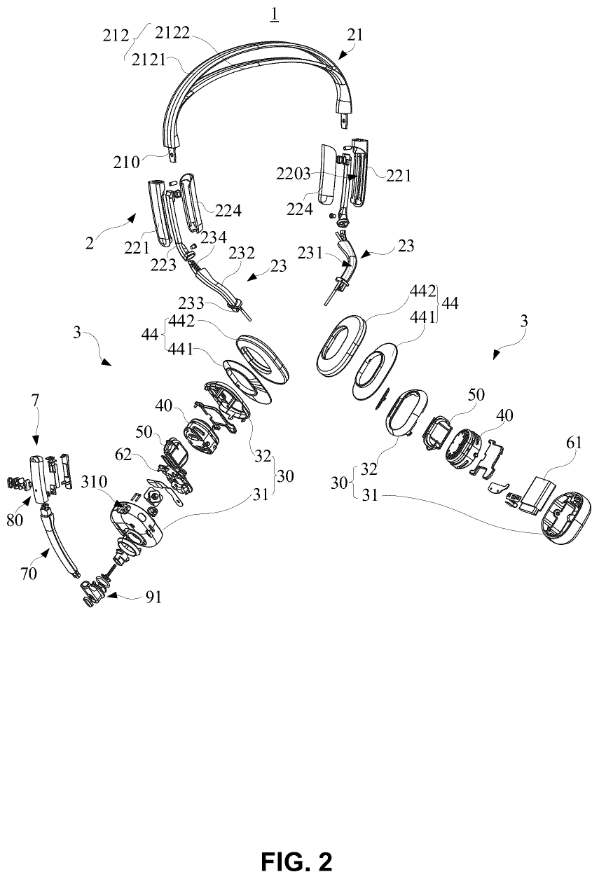

As shown in FIG. 2, the wearing assembly 2 may include a headband assembly 21, a telescopic assembly 22, and a torsion assembly 23. A count of the telescopic assembly 22 may be two, and a count of the torsion assembly 23 may be two. Two ends of the headband assembly 21 are connected to the two telescopic assemblies 22 in a one-to-one correspondence, and the two telescopic assemblies 22 are connected to the two torsion assemblies 23 in a one-to-one correspondence. The two torsion assemblies 23 are connected to the two speaker assemblies 3 in a one-to-one correspondence. The headband assembly 21 is configured to wrap around the top of the user's head, and a shape of the headband assembly 21 may match a contour of the user's head, which makes the user more comfortable and stable when wearing the headband assembly 21. The headband assembly 21 is further configured to elastically clamp two sides of the user's head. The telescopic assembly 22 is capable of a telescopic movement to change a length of the telescopic assembly 22, thereby changing a distance between the headband assembly 21 and the speaker assembly 3. Therefore, an adaptive adjustment can be performed according to different head shapes of different users, so as to position the speaker assembly 3 at a suitable position, thereby improving a compatibility of the wearing assembly 2. The torsion assembly 23 may generate an elastic torsion. Therefore, the torsion assembly 23 can generate torsion when the speaker assembly 3 contacts the user's head in a wearing state, so that the speaker assembly 3 can better contact the user's face or position at the user's ear.

As described in FIG. 2, the headband assembly 21 may include a clamping assembly 210 and a first elastic cover body 212. The clamping assembly 210 may include an elastic sheet that realizes an elastic clamping function. The first elastic cover body 212 may include a cover main body 2121 and an elastic band 2122 integrally molded with the cover main body 2121. The cover main body 2121 is molded to cover a periphery of the clamping assembly 210 and wires. Two ends of the elastic band 2122 are spaced apart from each other along a length direction of the clamping assembly 210 and connected to the cover main body 2121, respectively. The elastic band 2122 and the cover main body 2121 are separated from each other between connection positions of the ends of the elastic band 2122 and the cover main body 2121. The elastic band 2122 is configured to assist in positioning the clamping assembly 210 on the user's head in the wearing state.

As shown in FIG. 2, for each of the two telescopic assemblies 22, the telescopic assembly 22 may include a fixing portion 221 and a telescopic portion 223 telescopically disposed relative to the fixing portion 221. Two ends of the clamping assembly 210 are fixed (e.g., fixed via a plug connection) with the fixing portions 221 of the two telescopic assemblies 22, respectively. The telescopic assembly 22 may include a decorative portion 224. The fixing portion 221 is provided with a sliding groove 2203, the telescopic portion 223 is slidably provided within the sliding groove 2203, and the decorative portion 224 is assembled and fixed with the fixing portion 221 (e.g., capped to each other) to cover the sliding groove 2203 and a portion of the telescopic portion 223 provided within the sliding groove 2203.

As shown in FIG. 2, for each of the two torsion assemblies 23, the torsion assembly 23 may include an elastic connection member 231, a second elastic cover body 232, a first plugging portion 233, and a second plugging portion 234. The first plugging portion 233 and the second plugging portion 234 are disposed at both ends of the elastic connection member 231. The elastic connection member 231 is generally indicated by dashed lines in FIG. 2. The second elastic cover body 232 is molded to cover a periphery of the elastic connection member 231, and the wires are threaded within the second elastic cover body 232. The first plugging portion 233 cooperates with a plugging hole 310 of the speaker assembly 3 via a plug connection, and the second plugging portion 234 cooperates with a plugging hole (not labeled) of the telescopic portion 223 via a plug connection.

As shown in FIG. 2, for each of the two speaker assemblies 3, the speaker assembly 3 may include a housing assembly 30, a bone conduction speaker 40, and an air conduction speaker 50. The speaker assembly 3 may also include at least one of a battery 61 and a control circuit board 62. The housing assembly 30 is configured to accommodate the bone conduction speaker 40 and the air conduction speaker 50. The bone conduction speaker 40 is configured to contact the user's face, and the air conduction speaker 50 is configured to transmit air conduction sound waves to the user's ear canal. When the earphone 1 is worn on the user's head, the wearing assembly 2 may position the speaker assembly 3 at a facial region anterior to the user's tragus in the wearing state.

As shown in FIG. 2, the housing assembly 30 may include a main housing 31 and a main cover 32. The main housing 31 may have an open end, and the main cover body 32 caps at the open end of the main housing 31. The main cover body 32 may be provided with a sound outlet (not labeled) for the air conduction speaker 50 to emit sounds. A portion of the bone conduction speaker 40 may be exposed through the open end of the main housing 31 for contacting the user's face. Vibration directions of the bone conduction speaker 40 and the air conduction speaker 50 may be perpendicular to each other. At this situation, the bone conduction speaker 40 and the air conduction speaker 50 may be assembled on the main housing 31 to minimize a mutual interference between the bone conduction speaker 40 and the air conduction speaker 50. The bone conduction speaker 40 may be provided with an auxiliary facial contact assembly 44 for the comfort of the facial contact. The auxiliary facial contact assembly 44 is configured to increase a contact area between the bone conduction speaker 40 and the user's face in the wearing state, thereby improving a wearing comfort. The auxiliary facial contact assembly 44 may include a hard support member 441 and a soft contact member 442. The hard support member 441 is configured to support the soft contact member 442, thereby improving a structural strength and stability of the auxiliary facial contact assembly 44. The soft contact member 442 is configured to face the user's face and contact the user's face. Therefore, the soft contact member 442 can be more stably and tightly contact the user's face under the support of the hard support member 441.

As shown in FIG. 2, the speaker assembly 3 may include at least one of the control circuit board 62 and the battery 61. For example, one of the two speaker assemblies 3 includes the control circuit board 62, and the other speaker assembly 3 does not include the control circuit board 62, but includes the battery 61. Connection wires between the two speaker assemblies 3 are threaded across the wearing assembly 2. For example, one speaker assembly 3 includes the control circuit board 62 and the battery 61. Alternatively, a count of the control circuit board 62 may be two, and each of the two speaker assemblies 3 may include one control circuit board 62. A count of the battery 61 may be two, and each of the two speaker assemblies 3 may include one battery 61.

The stick microphone assembly 7 is disposed on one of the two speaker assemblies 3 in a rotatable manner. The stick microphone assembly 7 may include a stick body assembly 70, a microphone assembly 80, and a shaft mechanism 91. The microphone assembly 80 and the shaft mechanism 91 may be connected to two ends of the stick body assembly 70, and the shaft mechanism 91 is rotatably connected to the speaker assembly 3. In the wearing state, the shaft mechanism 91 may position the microphone assembly 80 at a pickup region of the user's mouth by rotating relative to the speaker assembly 3. The microphone assembly 80 is provided with at least one microphone and at least one related button. The at least one related button may be configured to turn on or off the at least one microphone.

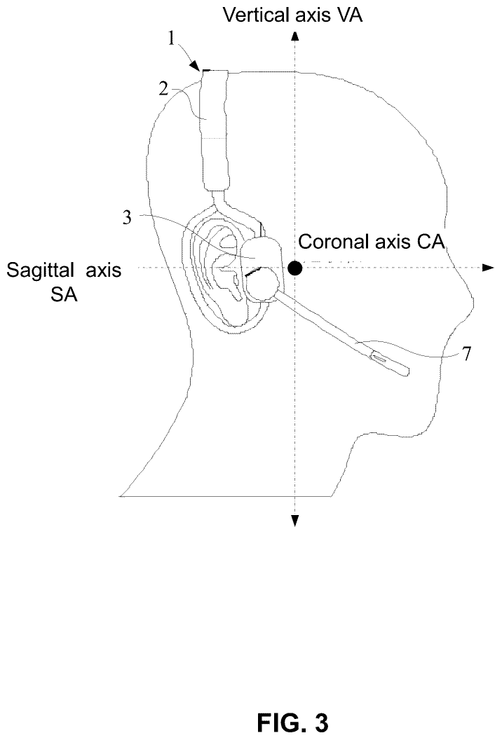

In fields of medicine, anatomy, etc., three basic sections (a sagittal plane, a coronal plane, and a horizontal plane) and three basic axes (a sagittal axis, a coronal axis, and a vertical axis) of a human body may be defined. The sagittal plane refers to a section along an anterior-posterior direction of the body and perpendicular to the ground, which divides the body into left and right parts. The coronal plane refers to a section along a left-right direction of the body and perpendicular to the ground, which divides the body into anterior and posterior parts. The horizontal plane refers to a section along an up-down direction of the body and parallel to the ground, which divides the body into upper and lower parts. Correspondingly, a sagittal axis SA refers to an axis along the anterior-posterior direction of the body and perpendicular to the coronal plane, the coronal axis refers to an axis along the left-right direction of the body and perpendicular to the sagittal plane, and the vertical axis VA refers to an axis along the upper-lower direction of the body and perpendicular to the horizontal plane. As shown in FIG. 3, when wearing the earphone 1, the wearing assembly 2 is clamped on two sides of the user's head, and the speaker assembly 3 is located at the facial region anterior to the tragus along the sagittal axis SA.

The following contents will describe the earphone 1 or some of the above-mentioned components, structures, etc., in detail. It should be understood that, some of the above-mentioned structures, components, such as the bone-conduction loudspeaker 40, the air-conduction loudspeaker 50, etc., can be used not only in the earphone 1, but also in other electronic devices, such as a cell phone, a speaker, a smart wearable device, etc.

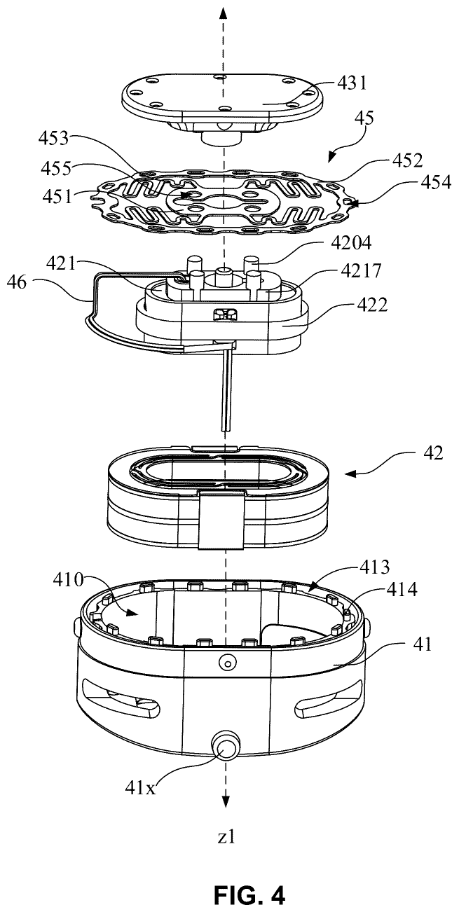

Optionally, as shown in FIG. 2, FIG. 3, and FIG. 4, in some embodiments, the speaker assembly 3 may include the bone conduction speaker 40. The bone conduction speaker 40 includes a core housing 41, a first vibration transmission sheet 45, a transducer 42, a vibration plate 431, and a wire 46.

The first vibration transmission sheet 45 includes an inner annular fixing portion 451, an outer annular fixing portion 452, and at least two elastic connection portions 453. The outer annular fixing portion 452 is disposed around a periphery of the inner annular fixing portion 451, and the at least two elastic connection portions 453 are connected between the inner annular fixing portion 451 and the outer annular fixing portion 452. The inner annular fixing portion 451 is connected to the transducer 42, the outer annular fixing portion 452 is connected to the core housing 41 so as to suspend the transducer 42 in the core housing 41, and the vibration plate 431 is connected to the transducer 42.

The wire 46 is connected to the transducer 42 and includes a first wire portion 461 extending from the inner annular fixing portion 451 to the outer annular fixing portion 452. When viewed along a vibration direction z1 of the vibration plate 431, the first vibration transmission sheet 45 has a long-axis direction LD1 and a short-axis direction SD1 perpendicular to each other, a size ld1 of the first vibration transmission sheet 45 along the long-axis direction LD1 is greater than a size sd1 of the first vibration transmission sheet 45 along the short-axis direction SD1, and an angle between the first wire portion 461 and the long-axis direction LD1 is smaller than an angle between the first wire portion 461 and the short-axis direction SD1.

By disposing the first vibration transmission sheet 45 to include the inner annular fixing portion 451, the outer annular fixing portion 452, and the at least two elastic connection portions 453, the transducer 42 can be suspended within the core housing 41 through the connection of the inner annular fixing portion 451 and the outer annular fixing portion 452 to the transducer 42 and the core housing 41, respectively. This allows the transducer 42 to move relative to the core housing 41, so that the transducer 42 vibrates within the core housing 41. Therefore, the speaker assembly 3 can convert the sounds into mechanical vibrations at different frequencies. When the speaker assembly 3 is worn on the user's head through the wearing component 2, it comes into contact with the user's facial cheekbone, directly transmitting sound for effective acoustic delivery and effectively improving a sound quality of the earphone 1. A count of the at least two elastic connection portions 453 may be 2, 4, 6, 8, etc. It should be noted that, the count of the at least two elastic connection portions 453 may be any other counts, and the wire 46 is disposed between adjacent elastic connection portions 453.

The wire 46 is connected to the transducer 42 and is configured to transmit an electrical signal to the transducer 42. By disposing that an angle between the first wire portion 461 and the long-axis direction LD1 is smaller than an angle between the first wire portion 461 and the short-axis direction SD1, a length of the first wire portion 461 can be increased, thereby effectively reducing a ratio of a stretched length relative to a total length of the first wire portion 461. The stretched length is generated by stretching the first wire portion 461 when the transducer 42 vibrates. This can effectively reduce a possibility that the transducer 42 excessively stretches the first wire portion 461 during the vibration of the transducer 42, thereby effectively improving a structural stability, a reliability, and a service life of the speaker assembly 3.

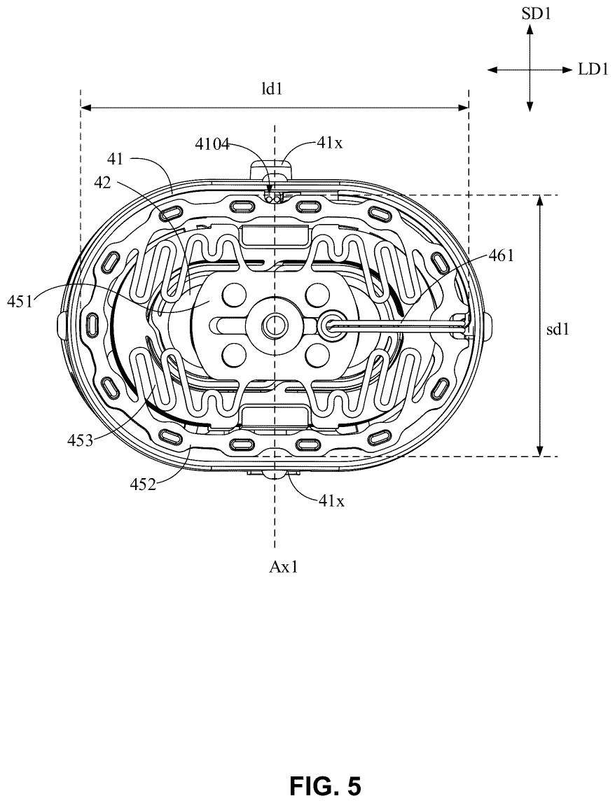

Optionally, as shown in FIG. 5, the first wire portion 461 is disposed along the long-axis direction LD1. That is, the angle between the first wire portion 461 and the long-axis direction LD1 is 0 degrees (°), and the angle between the first wire portion 461 and the short-axis direction SD1 is 90°. By disposing the first wire portion 461 along the long-axis direction LD1, the length of the first wire portion 461 can be increased while facilitating the positioning, thereby effectively reducing the possibility that the transducer 42 excessively stretches the first wire portion 461 during the vibration of the transducer 42, and effectively improving the structural stability, the reliability, and the service life of the speaker assembly 3. In some embodiments, the angle between the first wire portion 461 and the long-axis direction LD1 is 10°, and the angle between the first wire portion 461 and the short-axis direction SD1 is 80°. In some embodiments, the angle between the first wire portion 461 and the long-axis direction LD1 is 20°, and the angle between the first wire portion 461 and the short-axis direction SD1 is 70°. In some embodiments, the angle between the first wire portion 461 and the long-axis direction LD1 is 30°, and the angle between the first wire portion 461 and the short-axis direction SD1 is 60°.

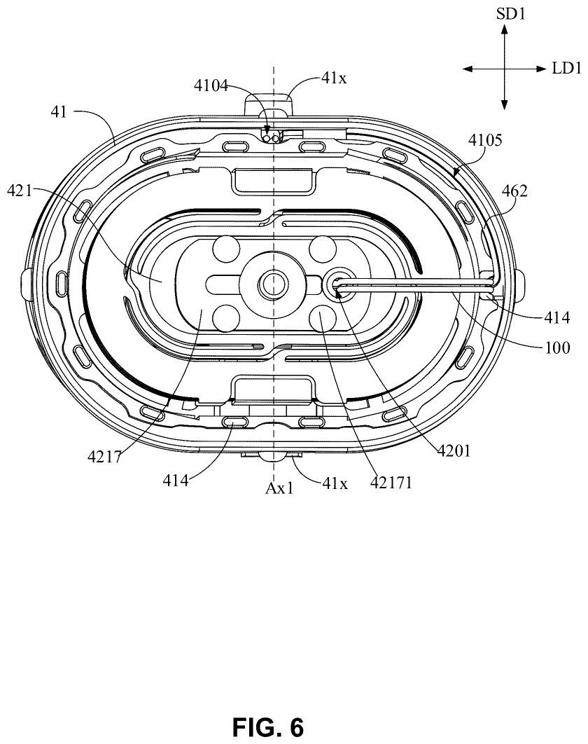

Optionally, as shown in FIG. 5 and FIG. 6, the core housing 41 is provided with shaft mechanisms 41x spaced apart from each other along the short-axis direction SD1. The shaft mechanisms 41x are configured to define a rotation axis Ax1, so that the core housing 41 rotates around the rotation axis Ax1. The wire 46 includes a second wire portion 462. The second wire portion 462 is connected to an end of the first wire portion 461 near the outer annular fixing portion 452 and extends toward the shaft mechanisms 41x along a circumferential direction of the core housing 41.

By disposing the shaft mechanisms 41x to cause the core housing 41 to rotate around the rotation axis Ax1, and by disposing the second wire portion 462 to connect to the end of the first wire portion 461 near the outer annular fixing portion 452 and extend toward the shaft mechanisms 41x along a circumferential direction of the core housing 41, a stretching/shaking degree of the second wire portion 462 during the rotation process of the core housing 41 is effectively reduced, thereby effectively reducing the possibility that the transducer 42 excessively stretches the first wire portion 461 during the vibration of the transducer 42, and effectively improving the structural stability, the reliability, and the service life of the speaker assembly 3.

Optionally, as shown in FIG. 6, the core housing 41 is provided with a wire groove 4105 along the circumferential direction of the core housing 41, and the second wire portion 462 is embedded in the wire groove 4105. By disposing the wire groove 4105 to accommodate the second wire portion 462, the second wire portion 462 is efficiently protected and fixed while facilitating the positioning and installation of the second wire portion 462. In addition, the risk of interference between the second wire portion 462 and the surrounding components during the vibration can be minimized, thereby effectively improving the operational reliability of the speaker assembly 3.

Optionally, as shown in FIG. 4 and FIG. 6, the outer annular fixing portion 452 is provided with a first hollow region 454, and the core housing 41 is provided with a first inset block 414. The first inset block 414 is further embedded in the first hollow region 454, and the wire groove 4105 further extends to the first insert block 414. The first vibration transmission sheet 45 may be a metal member, and the first insert block 414 may be a plastic member. The first vibration transmission sheet 45 may be made of a demagnetized metal material, such as, a demagnetized stainless steel, a demagnetized aluminum alloy, etc.

By cooperating the first hollow region 454 and the first insert block 414 to realize a connection between the first vibration transmission sheet 45 and the core housing 41, the structure is simple and easy to assemble, thereby effectively improving an assembly efficiency. The first vibration transmission sheet 45 is, for example, the metal member, and the first insert block 414 is, for example, the plastic member. That is, a hardness of the first insert block 414 is lower than a hardness of the first vibration transmission sheet 45, and the first insert block 414 may be embedded in the first hollow region 454 through a certain elastic deformation, thereby forming an interference fit between the first insert block 414 and the first hollow region 454 to improve the connection stability. The wire groove 4105 further extends to the first insert block 414 to position and install the wire 46, thereby effectively protecting the wire 46, and effectively reducing a possibility of damage to the wire 46 caused by the outer annular fixing portion 452 during the vibration of the transducer 42. This can improve the operational stability and reliability of the speaker assembly 3.

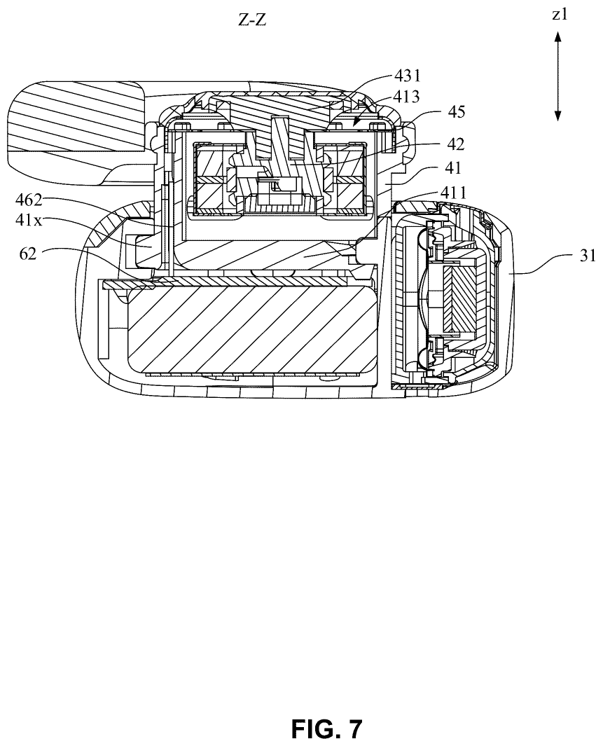

Optionally, as shown in FIG. 6 and FIG. 7, the core housing 41 is provided with a housing wire hole 4104. An extending direction of the housing wire hole 4104 intersects with the rotation axis Ax1, and the second wire portion 462 further passes through the housing wire hole 4104 and is configured to connect the control circuit board

By disposing the housing wire hole 4104, the electrical connection between the second wire portion 462 and the control circuit board 62 can be realized, thereby facilitating an output of the electrical signal from the control circuit board 62 and transmitting the electrical signal to the transducer 42. This can improve the operational stability and reliability of the speaker assembly 3.

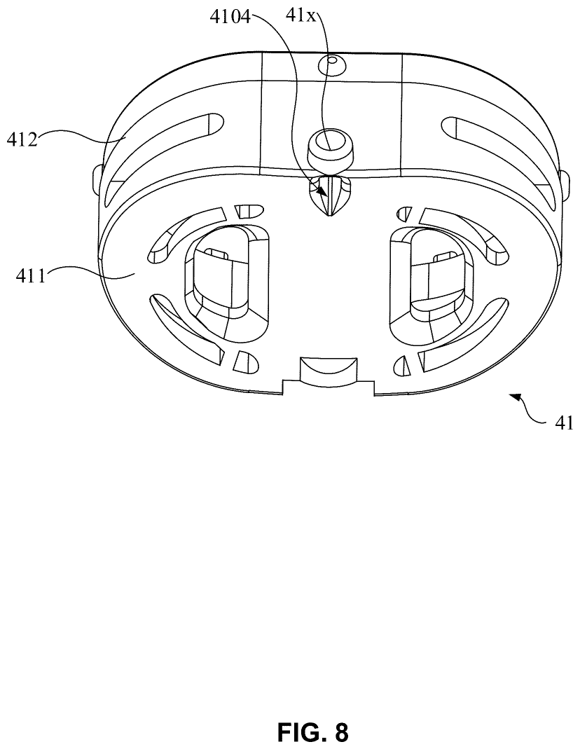

Optionally, as shown in FIG. 2, FIG. 4, and FIG. 8, the speaker assembly 3 further includes the main housing 31. The core housing 41 includes a bottom wall 411 and a circumferential sidewall 412 connected to the bottom wall 411, so as to form an accommodation space 410. An end of the accommodation space 410 has an opening. The transducer 42 is disposed in the accommodation space 410, the housing wire hole 4104 is disposed on the bottom wall 411, the shaft mechanisms 41x are disposed in the circumferential sidewall 412, the shaft mechanisms 41x rotationally supports the core housing 41 on the main housing 31, and the control circuit board 62 is disposed in the main housing 31 and is located on a side of the bottom wall 411 of the core housing 41 away from the transducer 42.

By disposing the transducer 42 in the accommodation space 410, disposing the housing wire hole 4104 on the bottom wall 411, and disposing the control circuit board 62 on the side of the bottom wall 411 of the core housing 41 away from the transducer 42, the second wire portion 462 can pass through the housing wire hole 4104 to connect the control circuit board 62, and an extension length required for the second wire portion 462 to pass through the housing wire holes 4104 is reduced, thereby effectively improving a layout rationality and a space utilization of the speaker assembly 3. This improves the structural integration of the speaker assembly 3.

Optionally, as shown in FIG. 7, along the vibration direction z1 of the vibration plate 431, a distance from one of the shaft mechanisms 41x to the bottom wall 411 is smaller than a distance from the shaft mechanism 41x to an open end 413 of the core housing 41. That is, the shaft mechanism 41x is closer to the bottom wall 411 than the open end 413, so as to provide a greater accommodation space 410 for the control circuit board 62 and reduce a possibility of interference of other parts on the control circuit board 62, thereby improving the operational stability and reliability of the speaker assembly 3.

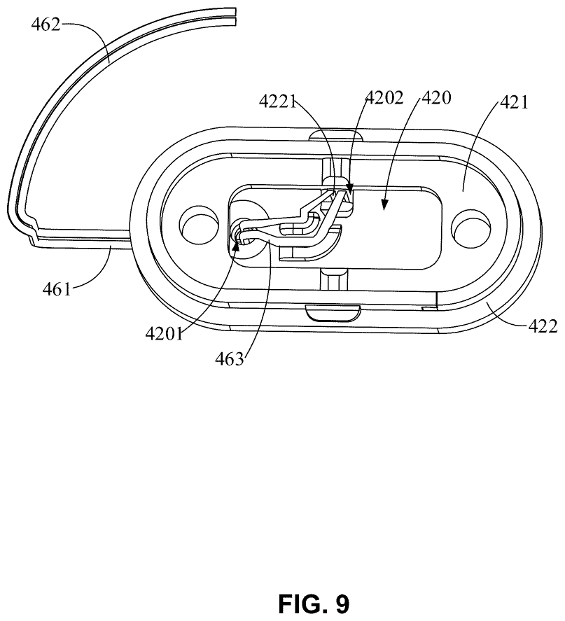

Optionally, as shown in FIG. 4 and FIG. 9, the transducer 42 includes a support 421 and a coil 422 disposed on the support 421. The support 421 is provided with a weight reduction chamber 420. The support 421 is connected to the inner annular fixing portion 451, and the support 421 is provided with a first support wire hole 4201. The first support wire hole 4201 is connected to the weight reduction chamber 420 and a side of the support 421 near the inner annular fixing portion 451. The wire 46 includes a third wire portion 463. The third wire portion 463 is connected to an end of the first wire portion 461 near the inner annular fixing portion 451, and extends into the weight reduction chamber 420 along the first support wire hole 4201. The third wire portion 463 is electrically connected to the coil 422.

By disposing the weight reduction chamber 420, the weight of the support 421 can be effectively reduced, thereby improving the vibration effect of the transducer 42. Additionally, the third wire portion 463 is connected to the end of the first wire portion 461 near the inner annular fixing portion 451 and extends into the weight reduction chamber 420 along the first support wire hole 4201 to electrically connect to the coil 422. This configuration minimizes the risk of interference between the third wire portion 463 and surrounding components during the vibration, thereby improving the operational stability and reliability of the speaker assembly 3.

Optionally, as shown in FIG. 4 and FIG. 6, the inner annular fixing portion 451 is provided with a second hollow region 455, and the support 421 is provided with a second insert block 4217. At least a portion of the second insert block 4217 is further embedded within the second hollow region 455. The first support wire hole 4201 is disposed on the second insert block 4217. The first vibration transmission sheet 45 may be a metal member, and the second insert block 4217 may be a plastic member. Optionally, the second insert block 4217 includes a plugging post 4204, and the plugging post 4204 is further embedded within the second hollow region 455.

By cooperating the second hollow region 455 and the second insert block 4217 to realize a connection between the inner annular fixing portion 451 and the support 421, the structure is simple and easy to assemble, thereby effectively improving an assembly efficiency. The first vibration transmission sheet 45 is, for example, the metal member, and the second insert block 4217 is, for example, the plastic member. That is, a hardness of the second insert block 4217 is lower than the hardness of the first vibration transmission sheet 45, and the second insert block 4217 may be embedded in the second hollow region 455 through a certain elastic deformation, thereby forming an interference fit between the second insert block 4217 and the second hollow region 455 to improve the connection stability. By disposing the first support wire hole 4201 on the second insert block 4217, the wire 46 can be effectively protected, thereby effectively reducing a possibility of damage to the wire 46 caused by the inner annular fixing portion 451 during the vibration of the transducer 42. This can improve the operational stability and reliability of the speaker assembly 3.

Optionally, as shown in FIG. 9, the coil 422 is wound around a periphery of the support 421. The support 421 is provided with a second support wire hole 4202, and the second support wire hole 4202 connects the weight reduction chamber 420 and the periphery of the support 421. A leading end 4221 of the coil 422 is further introduced to the weight reduction chamber 420 through the second support wire hole 4202 and connected to the third wire portion 463.

By disposing the second support wire hole 4202, the leading end 4221 of the coil 422 can be introduced to the weight reduction chamber 420 through the second support wire hole 4202, thereby minimizing the risk of interference between the coil 422 and the surrounding components during the vibration, thereby improving the operational stability and reliability of the speaker assembly 3.

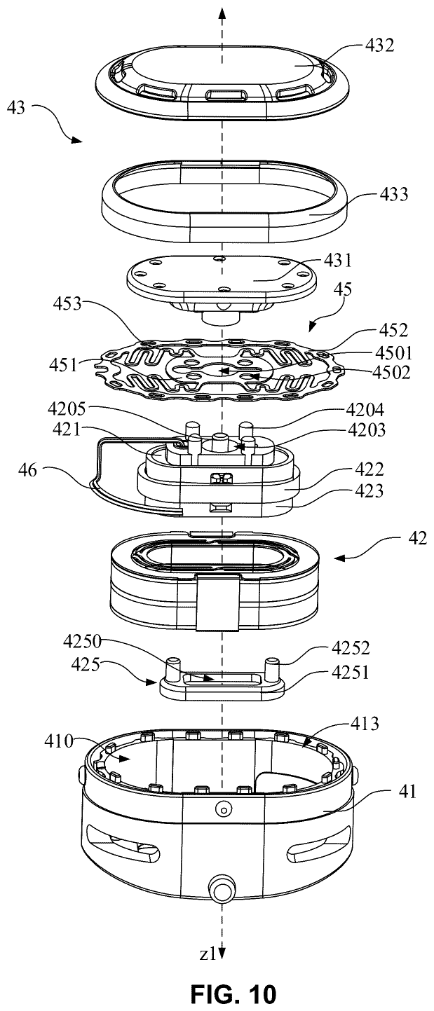

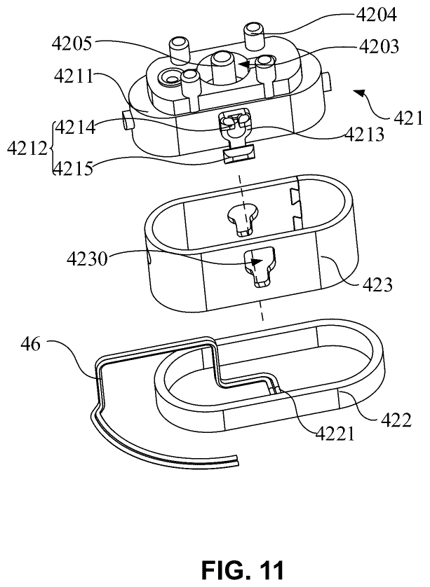

Optionally, as shown in FIG. 2, FIG. 10, and FIG. 11, in some embodiments, the speaker assembly 3 may include the bone conduction speaker 40. The bone conduction speaker 40 includes the transducer 42 and the vibration plate 431. The transducer 42 includes a magnetic conduction cover 423, the coil 422, and the support 421. The magnetic conduction cover 423 is arranged in a cylindrical shape and is provided with at least one connection hole 4230 connecting an inner wall surface and an outer wall surface of the magnetic conduction cover 423 along a radial direction of the magnetic conduction cover 423. The support 421 is molded to the magnetic conduction cover 423 and includes a support main body 4211, a limiting portion 4212, and at least one connection portion 4213. At least a portion of the support main body 4211 is disposed inside the inner wall surface, the limiting portion 4212 is disposed on the outer wall surface, and the at least one connection portion 4213 integrally connects the support main body 4211 and the limiting portion 4212 through the at least one connection hole 4230. The limiting portion 4212 is configured to limit the coil 422 disposed on the outer wall surface. The support main body 4211 is connected to the vibration plate 431.

By disposing the support 421 on the magnetic conduction cover 423 in the molding manner, the assembly process of the support 421 and the magnetic conduction cover 423 is simplified, and the assembly effect is improved. By disposing the connection portion 4213 to cooperate with the connection hole 4230, the stability and reliability of the connection between the support 421 and the magnetic conduction cover 423 can be effectively improved. The limiting portion 4212 is configured to limit the coil 422 to reduce a possibility of misalignment of the coil 422, thereby improving the vibration effect of the transducer 42, and thus improving the operational stability and reliability of the speaker assembly 3. The molding manner may include, for example, an injection molding, a compression molding, a thermoplastic molding, etc.

Optionally, as shown in FIG. 10 and FIG. 11, the limiting portion 4212 is disposed to abut against the coil 422 along an axial direction of the magnetic conduction cover 423, thereby limiting the coil 422 through the limiting portion 4212. Therefore, the coil 422 to be sleeved or wound on the magnetic conduction cover 423, thereby effectively reducing an assembly difficulty of the coil 422 and improving the assembly efficiency.

In some embodiments, the limiting portion 4212 is disposed in a ring shape along a circumferential direction of the magnetic conduction cover 423, so as to facilitate the limiting of the coil 422 disposed on the outer wall surface of the magnetic conduction cover 423, thereby effectively improving the limiting effect.

In some embodiments, the limiting portion 4212 is disposed to abut against the coil 422 on one side of the coil 422 along the axial direction of the magnetic conduction cover 423, so that the wound coil 422 can be smoothly sleeved on the periphery of the magnetic conduction cover 423 and then abut against the limiting portion 4212. The other side of the coil 422 is fixed by adhesive. The process can be simplified and the assembly difficulty can be reduced while limiting the coil 422, thereby improving the assembly efficiency.

Optionally, as shown in FIG. 10 and FIG. 11, the limiting portion 4212 includes a first sub-limiting portion 4214 and a second sub-limiting portion 4215 spaced apart along the axial direction of the magnetic conduction cover 423, and the coil 422 is wound between the first sub-limiting portion 4214 and the second sub-limiting portion 4215.

By disposing the first sub-limit portion 4214 and the second sub-limit portion 4215 at interval, the coil 422 can be wound between the first sub-limit portion 4214 and the second sub-limit portion 4215. Therefore, a blocking limiting may be performed on the coil 422 along the axial direction of the magnetic conduction cover 423, and the two sides of the coil 422 can be abutted against, thereby effectively improving the limiting effect.

Optionally, a material density of the support 421 is smaller than a material density of the magnetic conduction cover 423, thereby lowering the weight of the support 421. Therefore, the vibration effect of the transducer 42 can be improved, thereby improving a sound quality of the speaker assembly 3.

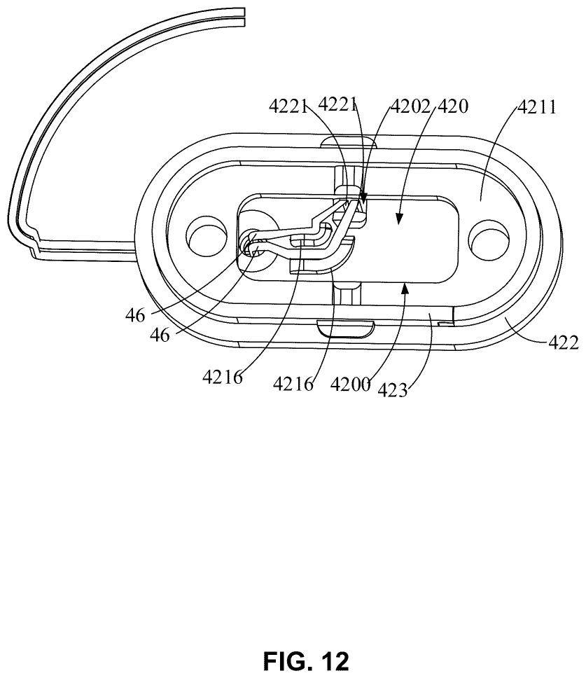

Optionally, as shown in FIG. 12, the support main body 4211 is provided with the weight reduction chamber 420, the at least one connection portion 4213 is provided with the support wire hole 4202, and the leading end 4221 of the coil 422 further extends into the weight reduction chamber 420 through the support wire hole 4202.

By disposing the weight reduction chamber 420, the weight of the support 421 can be effectively reduced, thereby improving the vibration effect of the transducer 42 and making the speaker assembly 3 lighter. The leading end 4221 of the coil 422 extends into the weight reduction chamber 420 through the support wire hole 4202. On the one hand, the leading end 4221 of the coil 422 extends into the weight reduction chamber 420, which is convenient for the leading end 4221 of the coil 422 to connect to the wire 46, thereby improving an assembly convenience. On the other hand, this configuration minimizes the risk of interference between the leading end 4221 and the surrounding components during the vibration, thereby improving the operational stability and reliability of the speaker assembly 3.

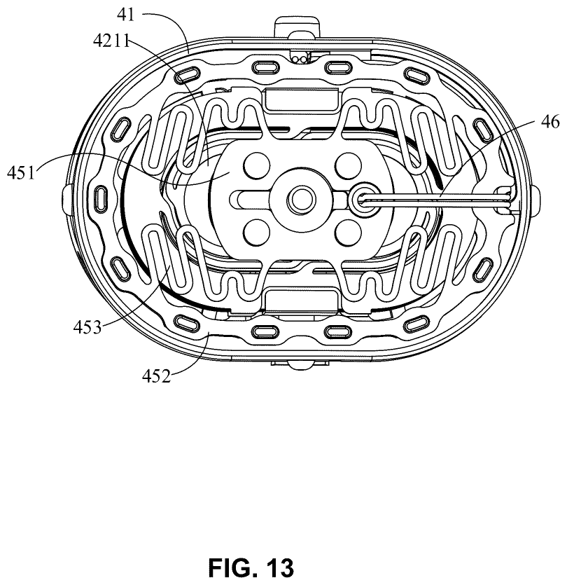

Optionally, as shown in FIG. 10 and FIG. 13, the bone conduction speaker 40 further includes the core housing 41, the first vibration transmission sheet 45, and the wire 46. The first vibration transmission sheet 45 includes the inner annular fixing portion 451, the outer annular fixing portion 452, and the at least two elastic connection portions 453. The outer annular fixing portion 452 is disposed around the periphery of the inner annular fixing portion 451, the at least two elastic connection portions 453 are connected between the inner annular fixing portion 451 and the outer annular fixing portion 452, the inner annular fixing portion 451 is connected to the support main body 4211, the outer annular fixing portion 452 is connected to the core housing 41, and the wire 46 is configured to connect to the leading end 4221 of the coil 422 within the weight reduction chamber 420.

By disposing the first vibration transmission sheet 45 to include the inner annular fixing portion 451, the outer annular fixing portion 452, and the at least two elastic connection portions 453, the transducer 42 can be suspended within the core housing 41 through the connection of the inner annular fixing portion 451 and the outer annular fixing portion 452 to the transducer 42 and the core housing 41, respectively. This allows the transducer 42 to move relative to the core housing 41, so that the transducer 42 vibrates within the core housing 41. Therefore, the speaker assembly 3 can convert the sounds into mechanical vibrations at different frequencies. When the speaker assembly 3 is worn on the user's head through the wearing component 2, it comes into contact with the user's facial cheekbone, directly transmitting sound for effective acoustic delivery and effectively improving a sound quality of the earphone 1. By disposing the wire 46 to connect to the leading end 4221 of the coil 422 within the weight reduction chamber 420, the risk of interference between the leading end 4221 of the coil 422 and the surrounding components during the vibration can be minimized, thereby improving the operational stability and reliability of the speaker assembly 3.

Optionally, as shown in FIG. 12, the wire 46 and the leading end 4221 may include two corresponding groups. The support main body 4211 is provided with a spacing mechanism 4216 disposed in the weight reduction chamber 420. The spacing mechanism 4216 is configured to make the two groups of wires 46 and leading ends 4221 maintain a preset spacing, thereby effectively reducing a possibility of a short circuit, and improving the operational stability and reliability of the speaker assembly 3.

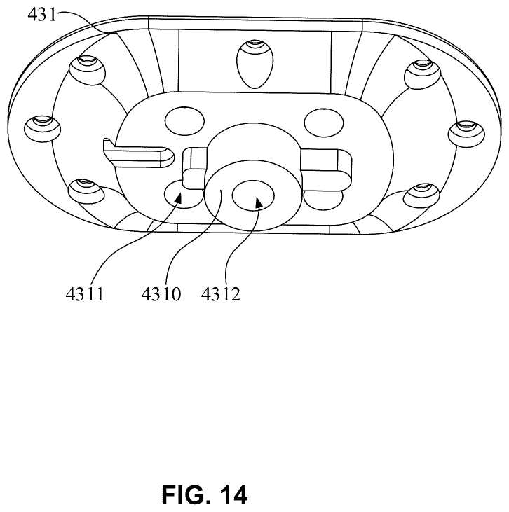

Optionally, as shown in FIG. 10, FIG. 11, and FIG. 14, a side of the support main body 421 facing the inner annular fixing portion 451 is provided with a first plugging hole 4203 and a plurality of first plugging posts 4204. The plurality of first plugging posts 4204 are disposed around a periphery of the first plugging hole 4203 and spaced apart from each other. The inner annular fixing portion 451 is provided with an exposed hole 4501 and a plurality of assembly holes 4502. The plurality of assembly holes 4502 are disposed around a periphery of the exposed hole 4501 and spaced apart from each other. The first plugging hole 4203 is exposed through the exposed hole 4501, and each of the plurality of first plugging posts 4204 is inserted into a corresponding assembly hole 4502. The connection plate 431 is provided with a second plugging post 4310 and a plurality of second plugging holes 4311. The plurality of second plugging holes 4311 are disposed around a periphery of the second plugging post 4310 and spaced apart from each other. The second plugging post 4310 is plugged into the first plugging hole 4203, and the plurality of first plugging posts 4204 are plugged into the plurality of second plugging holes 4311, respectively.

By disposing the second plugging post 4310 to plug into the first plugging hole 4203, and the plurality of first plugging posts 4204 to plug into the plurality of second plugging holes 4311, respectively, and by disposing the exposed hole 4501 to expose the first plugging hole 4203, the plurality of assembly holes 4502 can be disposed, so that the plurality of first plugging posts 4204 to plug into the plurality of second plugging holes 4311 through the plurality of assembly holes 4502. Therefore, the support 421, the first vibration transmission sheet 45, and the vibration plate 431 can be connected, thereby effectively simplifying the structure, reducing the assembly difficulty, and improving the fixing effect between the support 421, the first vibration transmission sheet 45, and the vibration plate 431. This can effectively improve the stability of the connection.

Optionally, as shown in FIG. 11 and FIG. 14, the support main body 4211 is further provided with a third plugging post 4205 located within the first plugging hole 4203. The vibration plate 431 is provided with a third plugging post 4312 located on the second plugging post 4310. The third plugging post 4205 is plugged into the third plugging hole 4312.

By disposing the third plugging post 4205 and the third plugging hole 4312, the support 421 and the vibration plate 431 can be further connected and fixed, thereby effectively improving the stability and reliability of the connection.

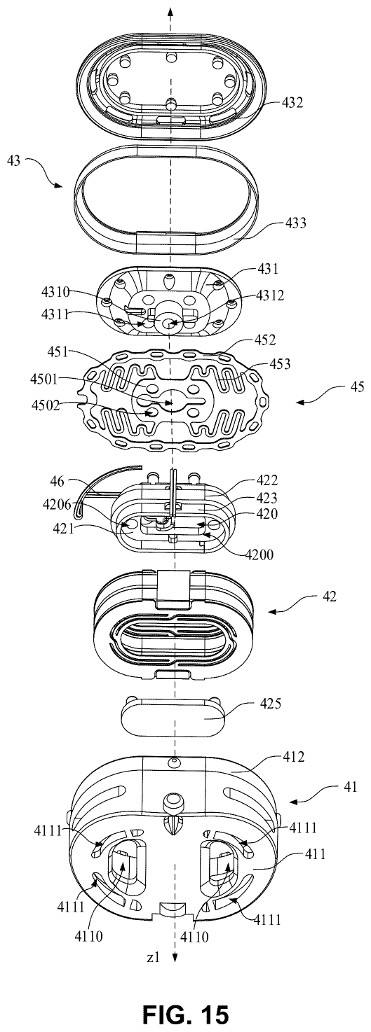

Optionally, as shown in FIG. 2, FIG. 10, and FIG. 15, in some embodiments, the speaker assembly 3 may include the bone conduction speaker 40. The bone conduction speaker 40 includes the core housing 41, the first vibration transmission sheet 45, the vibration plate 431, the transducer 42, and a cover body 425. The transducer 42 includes the support 421. The first vibration transmission sheet 45 connects the support 421 and the core housing 41 to suspend the transducer 42 within the core housing 41. The vibration plate 431 connects to the support 421, and the support 421 is provided with the weight reduction chamber 420 (also referred to as a first weight reduction chamber 420). The first weight reduction chamber 420 is located within the core housing 41 and has an open end 4200. The cover body 425 is configured to cap the open end 4200 of the first weight reduction chamber 420.

By suspending the transducer 42 within the core housing 41, i.e., the transducer 42 can move relative to the core housing 41, so that the transducer 42 vibrates inside the core housing 41. Therefore, the speaker assembly 3 can convert the sounds into the mechanical vibrations at different frequencies. When the speaker assembly 3 is worn on the user's head through the wearing component 2, it comes into contact with the user's facial cheekbone, directly transmitting sound for effective acoustic delivery and effectively improving a sound quality of the earphone 1. By disposing the first weight reduction chamber 420, the weight of the support 421 may be effectively reduced, thereby improving the vibration effect of the transducer 42 and making the speaker assembly 3 lighter. Therefore, the operational stability and reliability of the speaker assembly 3 can be improved, thereby improving the sound quality of the earphone 1.

In addition, since the transducer 42 generates sound waves when vibrating within the core housing 41, if the first weight reduction chamber 420 is not capped, the first weight reduction chamber 420 may be connected to an acoustic chamber for the sound waves to vibrate within the core housing 41, thereby increasing a volume of the acoustic chamber. Therefore, sound leakage is increased. Therefore, by disposing the cover body 425 to cover the open end 4200 of the first weight reduction chamber 420, the volume of the acoustic chamber can be reduced, so that a frequency of the sound waves of the sound leakage is shifted to a high frequency that is difficult for a human ear to hear, thereby reducing the sound leakage in a human vocal frequency band, and effectively improving the sound transmission effect and the sound quality of the speaker assembly 3.

Optionally, as shown in FIG. 10 and FIG. 15, the core housing 41 includes a bottom wall 411 and the circumferential sidewall 412 connected to the bottom wall 411, so as to form the accommodation space 410. The end of the accommodation space 410 has the opening. The transducer 42 is disposed in the accommodation space 410, and the open end 4200 of the first weight reduction chamber 420 is disposed toward the bottom wall 411.

By disposing the open end 4200 of the first weight reduction chamber 420 toward the bottom wall 411, it is convenient for the cover body 425 to cap the open end 4200 of the first weight reduction chamber 420 without obstructing a transmission of the sound waves to the user, thereby effectively improving the sound transmission effect and the sound quality of the speaker assembly 3.

Optionally, as shown in FIG. 10 and FIG. 15, the cover body 425 is disposed to seal the first weight reduction chamber 420 at a side of the open end 4200 of the first weight reduction chamber 420, thereby effectively separating the first weight reduction chamber 420 from the accommodation space 410. Therefore, the volume of the acoustic chamber for the sound waves to vibrate and the sound leakage in the human vocal frequency band can be reduced, thereby effectively improving the sound transmission effect and the sound quality of the speaker assembly 3.

Optionally, as shown in FIG. 10, a side of the cover body 425 facing the first weight reduction chamber 420 is provided with a second weight reduction chamber 4250, and the first weight reduction chamber 420 and the second weight reduction chamber 4250 are connected to each other. By disposing the second weight reduction chamber 4250 in the cover body 425, and disposing the second weight reduction chamber 4250 to connect to the first weight reduction chamber 420 rather than the accommodation space 410, the weight of the transducer 42 is further reduced to improve the vibration effect while effectively improving the sound transmission effect and the sound quality of the speaker assembly 3.

Optionally, the cover body 425 is removably connected to the support 421. Optionally, as shown in FIG. 9 and FIG. 14, the support 421 is provided with a plugging hole 4206 located at a periphery of the first weight reduction chamber 420. The cover body 425 includes a cover plate main body 4251 and a plugging post 4252 disposed on a side of the cover plate main body 4251. The plugging post 4252 is plug into the plugging hole 4206, and the cover plate main body 4251 caps the open end 4200 of the first weight reduction chamber 420.

By disposing the plugging post 4252 to match the plugging hole 4206 to realize a removeable connection between the cover body 425 and the support 421, the structure is simple, and easy to assemble and disassemble, thereby effectively reducing the assembly difficulty, and improving the assembly efficiency.

Optionally, as shown in FIG. 11 and FIG. 12, the transducer 42 further includes the coil 422. The coil 422 is wound around the periphery of the support 421. The support 421 is provided with the support wire hole 4202, and the support wire hole 4202 connects the first weight reduction chamber 420 and the periphery of the support 421. The leading end 4221 of the coil 422 is further introduced to the first weight reduction chamber 420 through the support wire hole 4202.

By extending the leading end 4221 of the coil 422 into the first weight reduction chamber 420 through the support wire hole 4202, on the one hand, the leading end 4221 of the coil 422 extends into the first weight reduction chamber 420, which is convenient for the leading end 4221 of the coil 422 to connect to the wire 46, thereby improving the assembly convenience. On the other hand, the risk of interference between the leading end 4221 of the coil 422 and the surrounding components during the vibration can be minimized, thereby improving the operational stability and reliability of the speaker assembly 3.

Optionally, as shown in FIG. 12, the bone conduction speaker 40 further includes the wire 46. The wire 46 is configured to connect to the leading end 4221 of the coil 422 within the first weight reduction chamber 420.

By connecting the wire 46 and the leading end 4221 of the coil 422 within the first weight reduction chamber 420 and capping the first weight reduction chamber 420 by the cover body 425, the electrical signals are transmitted to the coil 422 through the wire 46, and the risk of interference between a connection portion between the leading end 4221 of the coil 422 and the lead wire 46 and the surrounding components during the vibration can be minimized, thereby improving the operational stability and reliability of the speaker assembly 3.

Optionally, as shown in FIG. 11, the transducer 42 further includes the magnetic conduction cover 423. The magnetic conduction cover 423 is in the cylindrical shape and is provided with the at least one connection hole 4230 connecting the inner wall surface and the outer wall surface of the magnetic conduction cover 423 along the radial direction of the magnetic conduction cover 423. The coil 422 is wound on the outer wall surface, the support 421 is molded to the magnetic conduction cover 423 and includes the support main body 4211 and the at least one connection portion 4213. At least a portion of the support main body 4211 is disposed inside the inner wall surface, the at least one connection portion 4213 is disposed inside the at least one connection hole 4230, and the support wire hole 4202 is disposed on the at least one connection portion 4213.

By disposing the support 421 on the magnetic conduction cover 423 in the molding manner, the assembly process of the support 421 and the magnetic conduction cover 423 is simplified, and the assembly effect is improved. By disposing the connection portion 4213 to cooperate with the connection hole 4230, the stability and reliability of the connection between the support 421 and the magnetic conduction cover 423 can be effectively improved. The molding manner may include, for example, an injection molding, a compression molding, a thermoplastic molding, etc.

Optionally, as shown in FIG. 2, FIG. 10, and FIG. 15, in some embodiments, the speaker assembly 3 includes the bone conduction speaker 40. The bone conduction speaker 40 includes the core housing 41, a vibration transmission facial contact assembly 43, the first vibration transmission sheet 45, and the transducer 42. The core housing 41 includes the bottom wall 411 and the circumferential sidewall 412 connected to the bottom wall 411, so as to form the accommodation space 410. The end of the accommodation space 410 has the opening. The transducer 42 is placed in the accommodation space 410 through the open end 413 of the core housing 41. The transducer 42 includes the support 421, and the first vibration transmission sheet 45 connects the support 421 and the core housing 41 to elastically suspend the transducer 42 within the core housing 41. The vibration transmission facial contact assembly 43 is assembled and fixed to the support 421 along a spacing direction of the support 421 and the bottom wall 411. The bottom wall 411 is provided with through holes 4110 opposite to the support 421, and the through holes 4110 are disposed to allow a support fixture to be inserted into the accommodation chamber 410 through the through holes 4110 and support the support 421 when the vibration transmission face assembly 43 is assembled and fixed to the support 421.

By disposing the first vibration transmission sheet 45 to connect the support 421 and the core housing 41 so as to elastically suspend the transducer 42 within the core housing 41, i.e., relative positions of the transducer 42 and the core housing 41 can change. The transducer 42 can vibrate within the accommodation space 410 to reduce the vibration transmission to the core housing 41, thereby reducing the sound leakage due to the vibration of the core housing 41. The vibration transmission facial contact assembly 43 is assembled and fixed to the support 421 along the spacing direction between the support 421 and the bottom wall 411, so that the speaker assembly 3 can convert the electrical signals into the mechanical vibrations at different frequencies. When the speaker assembly 3 is worn on the user's head through the wearing component 2, it comes into contact with the user's facial cheekbone, directly transmitting sound for effective acoustic delivery and effectively improving a sound quality of the earphone 1. Optionally, a connection manner between the vibration transmission facial contact assembly 43 and the support 421 includes a plugging manner, an adhesive manner, a screw manner, etc.

Furthermore, as the first vibration transmission sheet 45 is suspended, the first vibration transmission sheet 45 is prone to elastically deform and misalign when other members are assembled. For example, when the vibration transmission facial contact assembly 43 is installed, as the vibration transmission facial contact assembly 43 is fixed to the support 421, a certain amount of pressure is exerted on the support 421 during the installation, resulting in the elastic deformation of the first vibration transmission sheet 45. Therefore, by disposing the through holes 4110 in the bottom wall 411 opposite to the support 421, the support fixture is inserted into the accommodation space 410 from the through holes 4110 to provide a supporting force for the support 421 during the assembly and fixation of the vibration transmission facial contact assembly 43 to the support 421, thereby effectively reducing a possibility of deformation of the first vibration transmission sheet 45. Therefore, an accuracy of the positioning and installation can be improved, thereby effectively reducing the assembly difficulty, and effectively improving the assembly efficiency and an assembly yield.

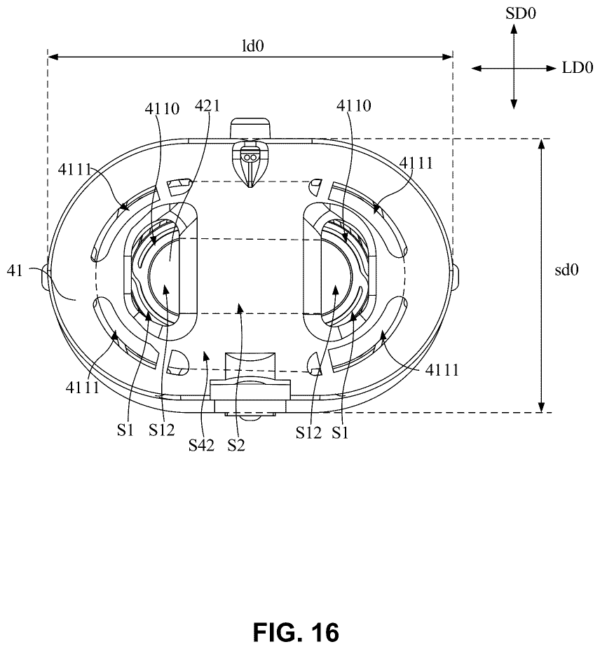

Optionally, as shown in FIG. 16, when viewed along the vibration direction z1 of the transducer 42, the bone conduction speaker 40 has a long-axis direction LD0 and a short-axis direction SD0, and a size of the bone conduction speaker 40 along the long-axis direction LD0 is greater than a size of the bone conduction speaker 40 along the short-axis direction SD0. A count of the through holes 4110 may be two, and the two through holes 4110 are spaced apart along the long-axis direction LD0.

When viewed along the vibration direction z1 of the transducer 42, the bone conduction speaker 40 may be in a shape of an ellipse, an olive, etc. The long-axis direction LD0 is a direction of a longest line segment by connecting two points at an outer edge of the bone conduction speaker 40 on a cross section (also referred to as a reference plane) perpendicular to the vibration direction z1 of the bone conduction speaker 40 through a center point of the cross section, and the short-axis direction SD0 is a direction of a shortest line segment by connecting two points at the outer edge of the bone conduction speaker 40 on the cross section through the center point. By disposing the two through holes 4110 spaced apart along the long-axis direction LD0, a greater installation operation space for the subsequent insertion of the support fixture can be provided compared to disposing the through holes 4110 along other directions, so that the support 421 is supported more stably. Therefore, the support 421 and the first vibration transmission sheet 45 can maintain a better balance and stability when assembled, thereby effectively improving the stability and reliability of the assembly process of the bone conduction speaker 40.

Optionally, as shown in FIG. 16, in the reference plane perpendicular to the vibration direction z1 of the transducer 42, the two through holes 4110 form first projection regions S1 in the reference plane along the vibration direction z1, the support 421 forms a second projection region S2 in the reference plane along the vibration direction z1, and an area ratio of an overlap portion S12 between the first projection regions S1 and the second projection region S2 to the second projection region S2 is greater than or equal to 0.3, for example, 0.35, 0.5, or 0.65.

If the area ratio is too small, the support of the support fixture to the support 421 may not be stable enough, resulting in a reduction of the assembly efficiency and the assembly accuracy. If the area ratio is too great, the support fixture may interfere with other portions or the structural strength may be deteriorated during the use of the support fixture. By reasonably setting the area ratio of the overlapping portion S12 between the first projection region S1 and the second projection region S2 to the second projection region S2, the support effect of the support fixture on the support 421 is effectively improved, and the possibility of the deformation of the first vibration transmission sheet 45 is effectively reduced, thereby effectively improving the accuracy of the positioning and installation, effectively reducing the assembly difficulty, and effectively improving the assembly efficiency and the assembly yield. In addition, by reasonably setting the through holes 4110, the sound in an inner chamber of the core housing 41 can be exported to cancel at least a portion of the sound leakage generated by the vibration of the core housing 41 to reduce the sound leakage, thereby effectively improving the sound transmission effect and the sound quality of the speaker assembly 3.

Optionally, as shown in FIG. 15 and FIG. 16, the bottom wall 411 is further provided with installation holes 4111 adjacent to an inner wall surface of the circumferential sidewall 412, and the installation holes 4111 are spaced apart from the through holes 4110. The installation holes 4111 are connected to the accommodation space 410. The installation holes 4111 are disposed to allow the support fixture to be inserted into the accommodation space 410 through the installation hole 4111 and support the support 421 when the vibration transmission facial contact assembly 43 is assembled and fixed to the support 421. By disposing the installation holes 4111, the support of the support 421 can be further improved, thereby effectively improving the accuracy of the positioning and installation, effectively reducing the difficulty of the assembly, and effectively improving the efficiency of the assembly and the assembly yield.

Optionally, as shown in FIG. 16, an area of the overlapping portion S12 between the first projection regions S1 formed by the through holes 4110 along the vibration direction z1 in the reference plane and the second projection region S2 formed by the support 421 along the vibration direction z1 in the reference plane accounts for more than or equal to 30% of an area of the first projection regions S1. An overlapping area between the first projection regions S1 and a third projection region S42 formed by the transducer 42 along the vibration direction z1 in the reference plane accounts for more than or equal to 70% of the area of the first projection regions S1. An overlapping area between a projection region formed by the installation holes 4111 and the through holes 4110 in the reference plane along the vibration direction z1 and the third projection region S42 accounts for more than or equal to 80% of an area of the projection region of the through holes 4110 and the installation holes 4111. By reasonably setting the area ratios, the support effect of the support fixture on the support 421 is effectively improved, thereby effectively reducing the possibility of the deformation of the first vibration transmission sheet 45, effectively improving the accuracy of the positioning and installation, effectively reducing the assembly difficulty, and effectively improving the assembly efficiency and the assembly yield.

Optionally, as shown in FIG. 11, the transducer 42 further includes the magnetic conduction cover 423. The magnetic conduction cover 423 is in the cylindrical shape and is provided with the at least one connection hole 4230 connecting the inner wall surface and the outer wall surface of the magnetic conduction cover 423 along the radial direction of the magnetic conduction cover 423. The support 421 is molded to the magnetic conduction cover 423 and includes a main body (i.e., the support main body 4211) of the support 421 and the at least one connection portion 4213. At least a portion of the support main body 4211 is disposed inside the inner wall surface, the at least one connection portion 4213 is disposed inside the at least one connection hole 4230, and the through holes 4110 are disposed to opposite to the main body of the support 421.

By disposing the support 421 on the magnetic conduction cover 423 in the molding manner, the assembly process of the support 421 and the magnetic conduction cover 423 is simplified, and the assembly effect is improved. By disposing the connection portion 4213 to cooperate with the connection hole 4230, the stability and reliability of the connection between the support 421 and the magnetic conduction cover 423 can be effectively improved. The vibration transmission facial contact assembly 43 is connected to the main body of the support 421, so as to assemble and fix the vibration transmission facial contact assembly 43 with the support 421. By setting the through holes 4110 opposite to the main body of the support 421, it is convenient for the support fixture to be inserted to provide the support force to the support main body, and the support force is opposite to a pressing force applied to the support main body when installing the vibration transmission facial contact assembly 43, thereby effectively reducing the possibility of the deformation of the first vibration transmission sheet 45, effectively improving the accuracy of the positioning and the installation, effectively reducing the assembly difficulty, and effectively improving the assembly efficiency and the assembly yield. The molding manner may include, for example, an injection molding, a compression molding, a thermoplastic molding, etc.

Optionally, as shown in FIG. 10 and FIG. 15, the first vibration transmission sheet 45 includes the inner annular fixing portion 451, the outer annular fixing portion 452, and at least two elastic connection portions 453. The outer annular fixing portion 452 is disposed around the peripheral of the inner annular fixing portion 451, the at least two elastic connection portions 453 are connected between the inner annular fixing portion 451 and the outer annular fixing portion 452, the inner annular fixing portion 451 is connected to the support 421, and the outer annular fixing portion 452 is connected to the core housing 41. A radial size of the vibration transmission facial contact assembly 43 is greater than a radial size of the outer annular fixing portion 452.

By disposing the inner annular fixing portion 451, the outer annular fixing portion 452, and at least two elastic connection portions 453 to realize an elastic connection between the support 421 and the core housing 41, and by disposing the radial size of the vibration transmission facial contact assembly 43 greater than the radial size of the outer annular fixing portion 452, the first vibration transmission sheet 45 can be avoided from being exposed to the outside, thereby improving an integrity of the structure of the bone conduction speaker 40. Therefore, a comfort of the earphone 1 contacting the cheek bone of the user's face when using the earphone 1 can be improved, a possibility of an entry of external sundries into an interior of the bone conduction speaker 40 can be reduced, thereby improving the service life of the earphone 1.

Optionally, as shown in FIG. 10 and FIG. 15, the vibration transmission facial contact assembly 43 includes the vibration plate 431, a soft vibration transmission member 432, and a hard support 433. A middle region of the soft vibration transmission member 432 is contacted and fixed to the vibration plate 431 in a molding manner, an edge region of the soft vibration transmission member 432 is fixed to the hard support 433 in the molding manner, the vibration plate 431 is plugged with the support 421 along the spacing direction, the hard support 433 is connected to the core housing 41, and a radial size of the hard support 433 is greater than the radial size of the outer annular fixing portion 452.

By contacting and fixing the middle region of the soft vibration transmission member 432 to the vibration plate 431 in the molding manner, and fixing the edge region of the soft vibration transmission member 432 to the hard support 433 in the molding manner, a contacting degree of the soft vibration transmission member 432 to the vibration plate 431 and the hard support 433 is effectively improved, thereby effectively improving the reliability and stability of the connection, effectively reducing the assembly difficulty, and simplifying the assembly process. The molding manner may include, for example, an injection molding, a compression molding, a thermoplastic molding, etc. In addition, by plugging the vibration plate 431 with the support 421 along the spacing direction and connecting the hard support 433 to the core housing 41, it facilitates the support 421 to transmit the vibrations to the vibration plate 431 without interfering with the suspension installation of the transducer 42. The vibrations are further transmitted to the user, thereby increasing the structural stability and reliability while realizing the good sound transmission effect. Therefore, the sound quality of the earphone 1 can be effectively improved.

Optionally, as shown in FIG. 10 and FIG. 15, the inner annular fixing portion 451 is plugged with the support 421 and clamped between the support 421 and the vibration plate 431. The structure is simple, thereby reducing the assembly difficulty and simplifying the assembly process, and improving the assembly efficiency and the assembly yield.

Optionally, as shown in FIG. 10 and FIG. 15, the side of the support main body 421 facing the inner annular fixing portion 451 is provided with the first plugging hole 4203 and the plurality of first plugging posts 4204. The plurality of first plugging posts 4204 are disposed around the periphery of the first plugging hole 4203 and spaced apart from each other. The inner annular fixing portion 451 is provided with the exposed hole 4501 and the plurality of assembly holes 4502. The plurality of assembly holes 4502 are disposed around the periphery of the exposed hole 4501 and spaced apart from each other. The first plugging hole 4203 is exposed through the exposed hole 4501, and each of the plurality of first plugging posts 4204 is inserted into the corresponding assembly hole 4502. The connection plate 431 is provided with the second plugging post 4310 and the plurality of second plugging holes 4311. The plurality of second plugging holes 4311 are disposed around the periphery of the second plugging post 4310 and spaced apart from each other. The second plugging post 4310 is plugged into the first plugging hole 4203, and the plurality of first plugging posts 4204 are plugged into the plurality of second plugging holes 4311, respectively.

By disposing the second plugging post 4310 to plug into the first plugging hole 4203, and the plurality of first plugging posts 4204 to plug into the plurality of second plugging holes 4311, respectively, and by disposing the exposed hole 4501 to expose the first plugging hole 4203, the plurality of assembly holes 4502 can be disposed, so that the plurality of first plugging posts 4204 to plug into the plurality of second plugging holes 4311 through the plurality of assembly holes 4502. Therefore, the support 421, the first vibration transmission sheet 45, and the vibration plate 431 can be connected, thereby effectively simplifying the structure, reducing the assembly difficulty, and improving the fixing effect between the support 421, the first vibration transmission sheet 45, and the vibration plate 431. This can effectively improve the stability of the connection.

Optionally, as shown in FIG. 10 and FIG. 15, the support main body 4211 is further provided with the third plugging post 4205 located within the first plugging hole 4203. The vibration plate 431 is provided with the third plugging post 4312 located on the second plugging post 4310. The third plugging post 4205 is plugged into the third plugging hole 4312.

By disposing the third plugging post 4205 and the third plugging hole 4312, the support 421 and the vibration plate 431 can be further connected and fixed, thereby effectively improving the stability and reliability of the connection.

As shown in FIG. 3, in some embodiments, the earphone 1 may include the speaker assembly 3 and the wearing assembly 2 connected to the speaker assembly 3. The wearing assembly 2 may be configured to position the speaker assembly 3 at the facial region anterior to the use's tragus in the wearing state. A region anterior to the tragus refers to a side of the tragus facing a direction of a nose. The speaker assembly 3 may be configured to be placed on the facial region anterior to the use's tragus, and contact the user's facial region. The speaker assembly 3 is configured to convert the electrical signals containing relevant audio information into sound wave signals and the vibration signals.

In some embodiments, as shown in FIG. 2, the speaker assembly 3 includes the bone conduction speaker 40. The bone conduction speaker 40 is configured to convert the electrical signals containing the audio information into the vibration signals. The bone conduction speaker 40 may contact the facial region anterior to the use's tragus, so that the bone conduction speaker 40 can transmit the vibration signals containing the audio information to the user.

Further, as shown in FIG. 4, the bone conduction speaker 40 may include the transducer 42. The transducer 42 is a main device in the bone conduction speaker 40 for converting the electrical signals into the vibration signals.

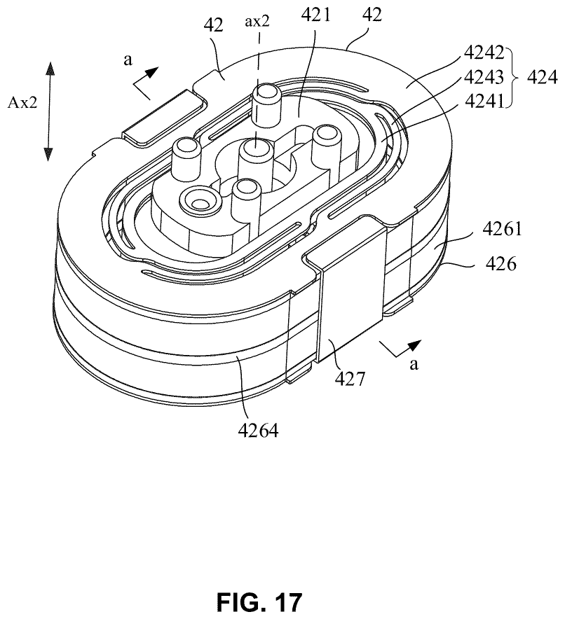

As shown in FIG. 17, the transducer 42 may include a clamp 427 and a magnetic circuit system 426. The magnetic circuit system 426 may include at least two annular magnets 4261. The at least two annular magnets 4261 may be stacked along an axial direction Ax2 of the magnetic circuit system 426, and adjacent annular magnets 4261 in the at least two annular magnets 4261 are arranged to repel each other along the axial direction Ax2. The clamp 427 may be disposed to clamp two outer end surfaces of the magnetic circuit system 426 away from each other along the axial direction Ax2. The axial direction Ax2 of the transducer 42 is indicated by an arrow Ax2 as shown in FIG. 17.

Specifically, after the transducer 42 is energized, the magnetic circuit system 426 can vibrate along the axial direction Ax2 of the transducer 42 under an action of an electric field and magnetic fields of the at least two annular magnets 4261, thereby driving the vibration transmission facial contact assembly 43 to vibrate.

By disposing the adjacent annular magnets 4261 to repel each other along the axial direction Ax2, the entire magnetic circuit system 426 can generate a greater magnetic field, thereby improving a magnetic field effect of a magnetic gap. However, due to their mutual repelling polarity, the adjacent annular magnets are prone to repel each other and shift position. When the magnetic circuit system 426 is vibrating, the at least two annular magnets 4261 also move along the axial direction Ax2 during the vibration. As a result, the at least two annular magnets 4261 are susceptible to displacement during operation and at rest, thereby loosening internal members of the transducer 42.

Optionally, as shown in FIG. 17, the clamp 427 may be disposed to clamp two sides of the at least two annular magnets 4261 away from each other along the axial direction Ax2. Therefore, the clamp 427 may fix the at least two annular magnets 4261 at the two sides of the at least two annular magnets 4261 away from each other, to minimize the displacement of the at least two annular magnets 4261 along the axial direction Ax2 due to the polarity repel, the vibration, etc.

Therefore, by disposing the clamp 427 to clamp the two outer end surfaces of the magnetic circuit system 426 away from each other, the relative displacement between the at least two annular magnets 4261 can be restricted, thereby reducing the likelihood of loosening and preventing failure of a conversion function of the transducer 42. Therefore, a structural stability, a tightness, a reliability, and a service life of the transducer 42 can be enhanced.

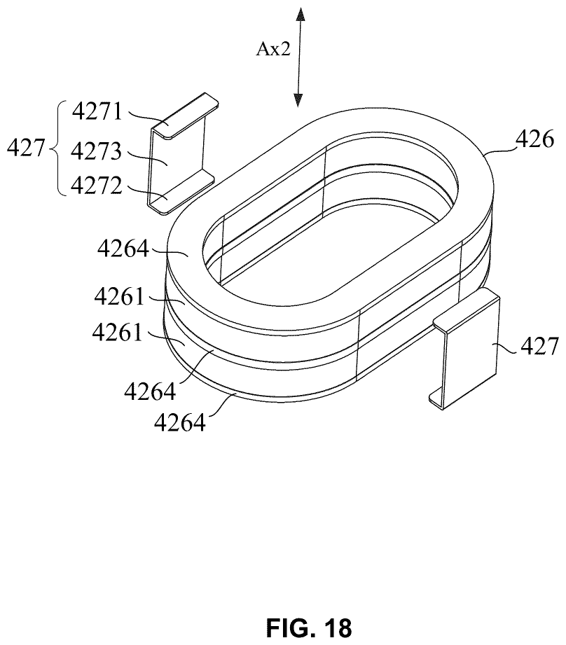

In some embodiments, as shown in FIG. 17 and FIG. 18, the magnetic circuit system 426 may further include at least three annular magnetic conduction plates 4264. The annular magnetic conduction plates 4264 are stacked with the at least two annular magnets 4261 along the axial direction Ax2 of the magnetic circuit system 426. A count of the annular magnetic conduction plates 4264 may correspond to a count of the annular magnets 4261. The annular magnetic conduction plates 4264 are overlapped with the annular magnets 4261, and the annular magnets 4261 may be separated by the annular magnetic conduction plates 4264. Each annular magnet 4261 is sandwiched between two adjacent annular magnetic conduction plates 4264.

For example, the count of the annular magnetic conduction plates 4264 may be three, and the count of the annular magnets 4261 may be two. Two of the annular magnetic conduction plates 4264 are disposed on two sides of the two annular magnets 4261 along the axial direction Ax2, and the other annular magnetic conduction plate 4264 is disposed at a middle position of the two annular magnets 4261. In this way, the annular magnetic conduction plates 4264 can be used to better fix the at least two annular magnets 4261, and allow magnetic induction lines of the at least two annular magnets 4261 to focus on the magnetic gap between the at least two annular magnets 4261, thereby improving the magnetic field effect of the magnetic gap and the sensitivity of the magnetic circuit system 426.

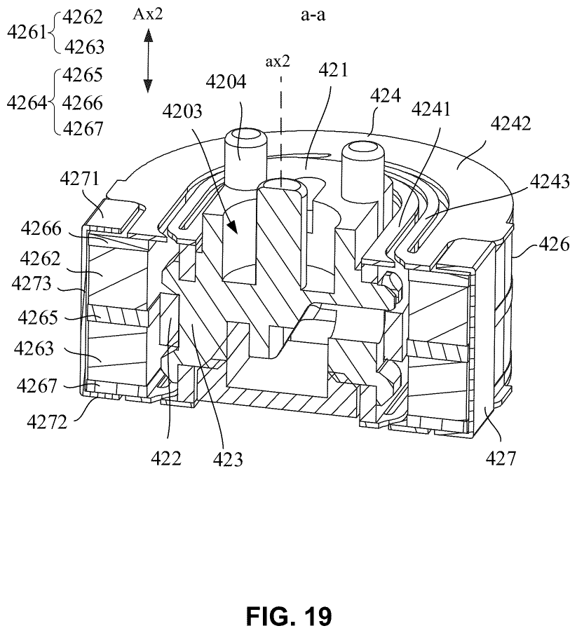

In some embodiments, as shown in FIG. 18 and FIG. 19, the clamp 427 may include a first abutment portion 4271, a second abutment portion 4272, and a connection portion 4273. The first abutment portion 4271 may abut against one of the two outer end surfaces of the magnetic circuit system 426, the second abutment portion 4272 may abut against the other one of the two outer end surfaces of the magnetic circuit system 426, and the connection portion 4273 may be connected between the first abutment portion 4271 and the second abutment portion 4272.

The first abutment portion 4271 and the second abutment portion 4272 are aligned along the axial direction Ax2 of the transducer 42, and abut against the two outer end surfaces of the magnetic circuit system 426, respectively, so as to fix with the magnetic circuit system 426 along the axial direction Ax2 of the transducer 42, thereby restricting the relative displacement between the at least two annular magnets 4261.

Optionally, the first abutment portion 4271 or the second abutment portion 4272 may abut against end surfaces of the annular magnetic conduction plates 4264 along the axial direction Ax2 of the transducer 42, so as to fix the at least two annular magnets 4261 through the annular magnetic conduction plates 4264.

The connection portion 4273 may be connected between the first abutment portion 4271 and the second abutment portion 4272, so as to further improve the limiting effect of the clamp 427.

In this way, the structure of the clamp 427 is simple and easy to manufacture. By using the clamp 427, the structure of the transducer 42 can be simplified, and the transducer 42 can stabilize the at least two annular magnets 4261 in the magnetic circuit system 426.

For example, in some embodiments, as shown in FIG. 18 and FIG. 19, the first abutment portion 4271, the second abutment portion 4272, and the connection portion 4273 are formed by bending a plate and are disposed in a U-shape. By bending the plate, the molding of a layer of the clamp 427 is facilitated and the manufacture process of the transducer 42 is simplified. In addition, the U-shape of the clamp 427 further simplifies the structure of the clamp 427, and also makes the clamp 427 easy to bend and mold. For example, the clamp 427 may be molded by stamping.

In some embodiments, the clamp 427 may be a non-magnetic body. In the transducer 42, the magnetic field on the magnetic circuit system 426 and an electric field of the internal members may cooperate to cause the transducer 42 to vibrate. Therefore, by disposing the clamp 427 as the non-magnetic body, the interference of the clamp 427 to the magnetic field can be reduced, so that a position of the transducer 42 is more stable and not eccentric. Therefore, the transducer 42 can operate more stably, thereby ensuring the vibration effect of the transducer 42.

In some embodiments, as shown in FIG. 18 and FIG. 19, the clamp 427 may include at least two clamps 427, and the at least two clamps 427 are disposed at intervals along a circumferential direction of the magnetic circuit system 426. In some embodiments, the at least two clamps 427 are spaced apart with uniform intervals along the magnetic circuit system 426, so that the relative displacement between the at least two annular magnets 4261 can be restricted and a center of gravity of the transducer 42 is located at a vibration axis, thereby ensuring the stability of the vibration of the transducer 42. For example, as shown in FIG. 19, the clamp 427 may include two clamps 427, and the two clamps 427 are disposed opposite to each other along the radial direction of the transducer 42 to clamp the magnetic circuit system 426 on the two sides of the transducer 42, and ensure that the center of gravity of the transducer 42 is located at the vibration axis.

By increasing the count of the clamp 427, the fixing effect on the at least two annular magnets 4261 can be strengthened, and the magnetic circuit system 426 can be subjected to a more uniform force, thereby improving the structural stability and a firmness of the transducer 42.

In some embodiments, as shown in FIG. 17 and FIG. 19, the transducer 42 may further include the support 421, the coil 422, and a vibration transmission sheet 424. The vibration transmission sheet 424 may connect the magnetic circuit system 426 and the support 421, to elastically suspend the magnetic circuit system 426 at the periphery of the support 421. The coil 422 may be disposed on the support 421 and located inside the magnetic circuit system 426. The connection portion 4273 is disposed on an outer side of the magnetic circuit system 426.

The support 421 may be disposed inside the at least two annular magnets 4261. The coil 422 may be fixed to the support 421 by winding along the radial direction of the support 421. The coil 422 corresponds to the at least two annular magnets 4261 to allow the electric field of the coil 422 to interact with the magnetic field of the annular magnets 4261 when the coil 422 is energized.

Specifically, by controlling a current through the coil 422, the electrical signals containing the relevant audio information passes through the coil 422. Since the coil 422 is opposite to the at least two annular magnets 4261 in the radial direction of the transducer 42, the electric field of the coil 422 and the magnetic field of the at least two annular magnets 4261 may interact with each other, thereby causing a mutual movement between the magnetic circuit system 426 and the support 421 where the coil 422 is located.

In some embodiments of the present disclosure, the connection portion 4273 is disposed on the outer side of the magnetic circuit system 426. In other words, the clamp 427 is disposed on the outer side surface of the magnetic circuit system 426 away from the support 421. In this way, a gap between the magnetic circuit system 426 and the coil 422 occupied by the support 421 can be reduced, which in turn makes the structure more compact, thereby improving the interaction between the magnetic field of the magnetic circuit system 426 and the electric field of the coil 422. Moreover, the position of the clamp 427 also facilitates the assembly of the clamp 427 on the magnetic circuit system 426, thereby reducing the production difficulty of the transducer 42.

Optionally, a count of the vibration transmission sheet 424 may be two, an the two vibration transmission sheets 424 may be sequentially arranged along the axial direction Ax2 of the transducer 42. The two vibration transmission sheets 424 are disposed on the support 421 and the magnetic circuit system 426 along two sides of the axial direction Ax2 to connect the support 421 and the magnetic circuit system 426 on the two sides of the axial direction Ax2. When the magnetic circuit system 426 generates the mutual movement along the axial direction Ax2 due to the interaction of the coil 422 on the support 421, the vibration transmission sheets 424 can drive the support 421 to move along the axial direction Ax2. By disposing the two vibration transmission sheets 424 to drive the support 421 to move or restore the support 421 along the axial direction Ax2, an elastic fixing effect between the support 421 and the magnetic circuit system 426 can be strengthened to make the structure of the transducer 42 more stable.

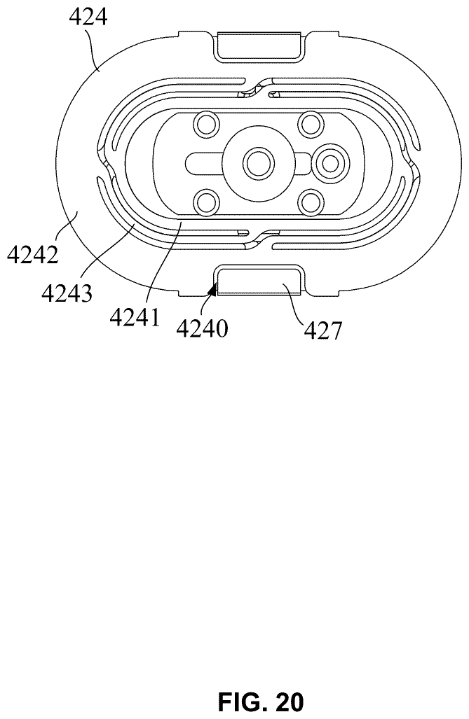

In some embodiments, as shown in FIG. 19 and FIG. 20, the vibration transmission sheet 424 may include an inner annular fixing portion 4241, an outer annular fixing portion 4242, and at least two elastic connection portions 4243.

The outer annular fixing portion 4242 may be disposed around a periphery of the inner annular fixing portion 4241, the at least two elastic connection portions 4243 are connected between the inner annular fixing portion 4241 and the outer annular fixing portion 4242, the inner annular fixing portion 4241 is connected to the support 421, and the outer annular fixing portion 4242 is connected to at least one of the two outer end surfaces of the magnetic circuit system 426. The magnetic circuit system 426 may drive the outer annular fixing portion 4242 to vibrate when the magnetic circuit system 426 vibrates relative to the support 421. The outer annular fixing portion 4242 connects to the inner annular fixing portion 4241 through the at least two elastic connection portions 4243, so that the vibration transmission sheet 424 can elastically constrain the relative movement between the coil 422 and the magnetic circuit system 426. When the transducer 42 vibrates, the vibration transmission sheet 424 may limit the support 421 within the magnetic circuit system 426 to remain the operation of the transducer 42 stable.

Further, as shown in FIG. 20, the outer annular fixing portion 4242 may be provided with at least one notch 4240. The at least one of the two outer end surfaces of the magnetic circuit system 426 is exposed from the at least one notch 4240, and the first abutment portion 4271 and/or the second abutment portion 4272 are disposed to abut against an exposed portion of the at least one of the two outer end surfaces of the magnetic circuit system 426 exposed from the at least one notch 4240.

The exposed portion of the magnetic circuit system 426 exposed from the at least one notch 4240 faces the axial direction Ax2 of the transducer 42, so that the first abutment portion 4271 and/or the second abutment portion 4272 can be disposed in the at least one notch 4240 and abutted against the exposed portion of the magnetic circuit system 426 in the axial direction Ax2 of the transducer 42.

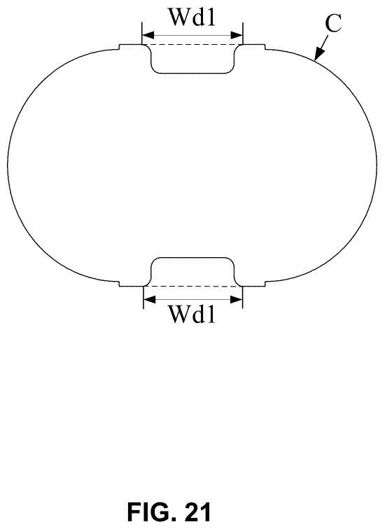

In some embodiments, as shown in FIG. 20 and FIG. 21, the at least one notch 4240 may include at least two notches 4240, and the at least two notches 4240 are spaced apart along a circumferential direction of the outer annular fixing portion 4242. Each of the at least two notches 4240 is connected to an outer edge of the outer annular fixing portion 4242. Along the circumferential direction of the outer annular fixing portion 4242, a ratio of a total width Wd1 of the at least two notches 4240 on the outer edge of the outer annular fixing portion 4242 to a circumference C of the outer edge of the outer annular fixing portion 4242 is within a range from 0.08 to 0.25.

Optionally, the circumference C of the outer edge of the outer annular fixing portion 4242 may be within a range from 35 millimeters (mm) to 65 mm. The total width Wd1 of the at least two notches 4240 on the outer edge of the outer annular fixing portion 4242 may be within a range from 5 mm to 16 mm. For example, the circumference C of the outer edge of the outer annular fixing portion 4242 may be 40.8mm, 57.3 mm, 64.5 mm, and the total width Wd1 of the at least two notches 4240 on the outer edge of the outer annular fixing portion 4242 may be 5.6 mm, 10.7 mm, 15.5 mm. The ratio of the total width Wd1 of the at least two notches 4240 on the outer edge of the outer annular fixing portion 4242 to the circumference C of the outer edge of the outer annular fixing portion 4242 is equal to 0.13, 0.18, 0.24.

In other embodiments, the ratio of the total width Wd1 of the at least two notches 4240 over the outer edge of the outer annular fixing portion 4242 to the circumference C of the outer edge of the outer annular fixing portion 4242 may be 0.14, 0.17, 0.21, etc.

If the ratio of the total width Wd1 to the circumference C is too great, the total width Wd1 of the at least two notches 4240 is too great, which affects the structural strength of the vibration transmission sheet 424. Therefore, by setting the reasonable ratio range, the structural strength of the vibration transmission sheet 424 can be ensured, so that the vibration transmission sheet 424 is less likely to undergo deformation, fracture, etc., when the transducer 42 vibrates. When the clamp 427 abuts against the exposed portion of the magnetic circuit system 426 through the at least two notches 4240, the magnetic circuit system 426 can be fixed more effectively by the clamp 427, thereby reducing the likelihood of loosening and preventing the failure of the conversion function of the transducer 42.

The at least two notches 4240 may correspond to the first abutment portions 4271 and/or the second abutment portions 4272 of the at least two clamps 427, and the first abutment portions 4271 and/or the second abutment portions 4272 of the at least two clamps 427 may be fixed to the portion of the magnetic circuit system 426 exposed from the at least two notches 4240 through the at least two notches 4240.

For example, the clamp may include the two clamps 427. The outer annular fixing portion 4242 is provided with two notches 4240 corresponding to each of the two clamps 427, and the two notches 4240 are arranged along the axial direction Ax2 of the transducer 42. One of the two notches 4240 corresponds to one of the two outer end surfaces of the exposed magnetic circuit system 426, and the other notch 4240 corresponds to the other one of the two outer end surfaces of the exposed magnetic circuit system 426. Two exposed portions of the exposed magnetic circuit system 426 correspond to the first abutment portion 4271 and the second abutment portion 4272, and the first abutment portion 4271 and the second abutment portion 4272 may abut against the exposed portion of the two outer end surfaces of the magnetic circuit system 426 exposed from the two notches 4240.

In this way, the structures of the clamp 427 and the vibration transmission sheet 424 are cooperated, which not only makes the structure of the transducer 42 more compact, but also reduces the size of the transducer 42 in the axial direction Ax2.

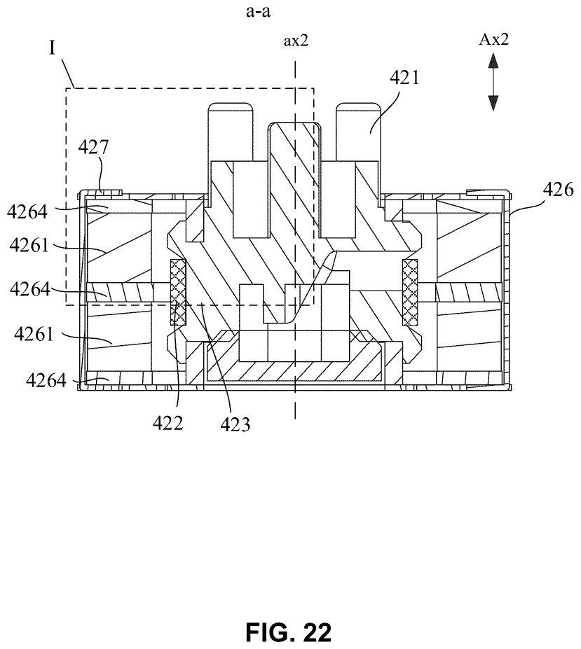

In some embodiments, as shown in FIG. 19 and FIG. 22, the transducer 42 further includes the magnetic conduction cover 423. The magnetic conduction cover 423 is in the cylindrical shape and connected to the support 421, and the coil 422 may be wound around the periphery of the magnetic conduction cover 423. The inner annular fixing portion 4241 is connected to the outer end surface of the magnetic conduction cover 423, and the vibration transmission sheet 424 may include a metal material. Specifically, the vibration transmission sheet 424 may be a magnetic conduction metal member.

The magnetic conduction cover 423 has a certain magnetic conductivity, and the magnetic conduction cover 423 is configured to constrain the magnetic field in the transducer 42. Specifically, the magnetic conduction cover 423 may form a magnetic flux path with the vibration transmission sheet 424 and the magnetic circuit system 426, and the coil 422 is wound around an outside of the magnetic conduction cover 423 to be disposed at a middle position of a region surrounded by the magnetic flux path. When the coil 422 is energized, the electric field of the coil 422 may interact with the magnetic field of the magnetic flux path, so that the coil 422 on the magnetic circuit system 426 and the support 421 can move along the axial direction Ax2, thereby driving the transducer 42 to vibrate.

In some embodiments, as shown in FIG. 22, the inner annular fixing portion 4241 is welded and fixed to the outer end surface of the magnetic conduction cover 423, and the outer annular fixing portion 4242 is welded and fixed to the outer end surface of the magnetic circuit system 426.

Optionally, the outer annular fixing portion 4242 may be welded and fixed to the outer end surface of the annular magnetic conduction plate 4264, and the annular magnetic conduction plate 4264 and the annular magnets 4261 may be fixed to each other, so that the annular magnets 4261 can drive the outer annular fixing portion 4242 to move through the annular magnetic conduction plate 4264 when the annular magnets 4261 moves.

The connection between the vibration transmission sheet 424, the magnetic circuit system 426, and the magnetic conduction cover 423 may be strengthened by welding, thereby strengthening a magnetic flux effect between the vibration transmission sheet 424, the magnetic circuit system 426, and the magnetic conduction cover 423, and improving the structural stability of the transducer 42.

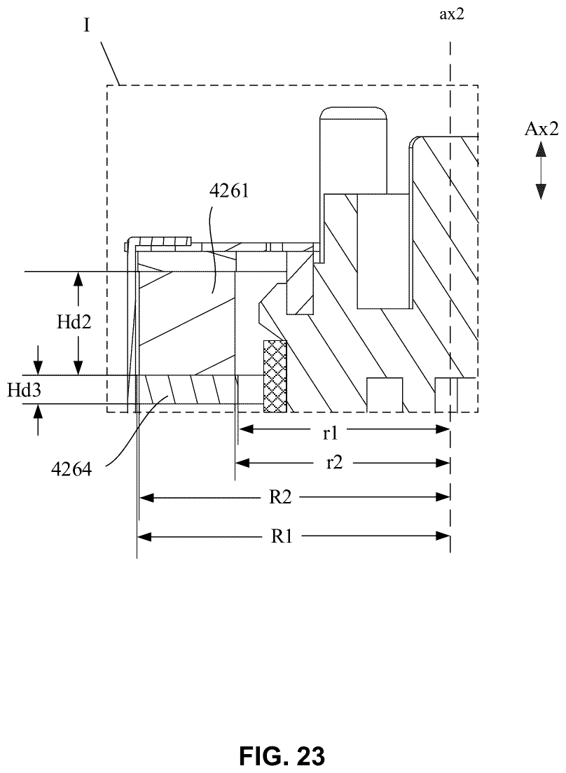

As shown in FIG. 22 and FIG. 23, in some embodiments of the present disclosure, an outer diameter R1 (also referred to as a first outer diameter) of the annular magnetic conduction plate 4264 may be greater than a second outer diameter R2 (also referred to as a second outer diameter) of the annular shaped magnet 4261, and an inner diameter r1 (also referred to as a first inner diameter) of the annular magnetic conduction plate 4264 may be smaller than an inner diameter r2 (also referred to as a second inner diameter) of the annular shaped magnet 4261.

As shown in FIG. 23, an axis of the magnetic circuit system 426 may be indicated by the line ax2 as shown in FIG. 23, and the axial direction Ax2 of the magnetic circuit system 426 may be shown in FIG. 23. The outer diameter R1 of the annular magnetic conduction plate 4264 may be indicated by the distance R1 as shown in FIG. 23, and the outer diameter R2 of the annular shaped magnet 4261 may be indicated by the distance R2 as shown in FIG. 23. R1 is greater than R2. The inner diameter r1 of the annular magnetic conduction plate 4264 may be indicated by the distance r1 as shown in FIG. 23, and the inner diameter r2 of the annular shaped magnet 4261 may be indicated by the distance r2 as shown in FIG. 23. r1 is smaller than r2.

In this way, the annular magnet 4261 can have a radial size smaller than the annular magnetic conduction plate 4264, and the annular magnet 4261 is disposed in a middle position of the annular magnetic conduction plate 4264. As a result, the annular magnet 4261 can achieve limited-amplitude movement within the extended portion of the annular magnetic conduction plate 4264 that exceeds the annular magnet 4261. In addition, this arrangement allows the manufacturing precision of the annular magnetic conduction plate 4264 to be higher than that of the annular magnet 4261. Consequently, during assembly, the annular magnetic conduction plate 4264 can serve as a positioning reference to facilitate accurate placement and alignment of the annular magnet 4261, thereby improving its positioning accuracy.

In some embodiments, as shown in FIG. 23, a ratio of a difference between the outer diameter R1 of the annular magnetic conduction plate 4264 and the outer diameter R2 of the annular magnet 4261 to a radial width of the annular magnet 4261 may be within a range from 0.002 to 0.007. That is, (R1−R2)/(R2−r2)=0.002-0.007.

The difference between the outer diameter R1 of the annular magnetic conduction plate 4264 and the outer diameter R2 of the annular magnet 4261 is a distance from an edge of the outer diameter R1 of the annular magnetic conduction plate 4264 to the outer diameter R2 of the annular magnet 4261.

Specifically, if the ratio is too great, the annular magnet 4261 can have a great movement amplitude in the radial direction. When the magnetic circuit system 426 vibrates, the magnetic circuit system 426 is prone to shift in the radial direction relative to the annular magnetic conduction plate 4264, resulting in the eccentricity of the transducer 42 that would adversely affect its vibration performance. If the ratio is too small, the annular magnet 4261 cannot be effectively positioned using the annular magnetic conduction plate 4264 as reference, increasing the assembly difficulty of the transducer 42. Therefore, by setting the ratio within the reasonable range, the positioning accuracy between the annular magnet 4261 and the annular magnetic conduction plate 4264 can be improved, and the movement amplitude of the annular magnet 4261 in the radial direction can be reduced, thereby better securing the position of the annular magnet 4261 within the transducer 42.

For example, the ratio of the difference between the outer diameter R1 of the annular magnetic conduction plate 4264 and the outer diameter R2 of the annular magnet 4261 to the radial width of the annular magnet 4261 may be 0.003, 0.005, 0.006, etc.

In some embodiments, the difference between the outer diameter R1 of the annular magnetic conduction plate 4264 and the outer diameter R2 of the annular magnet 4261 may be within a range from 0.02 mm to 0.08 mm.

For example, the difference between the outer diameter R1 of the annular magnetic conduction plate 4264 and the outer diameter R2 of the annular magnet 4261 may be 0.03 mm, 0.05 mm, 0.07 mm, etc.

Similarly, if the difference between the outer diameter R1 of the annular magnetic conduction plate 4264 and the outer diameter R2 of the annular magnet 4261 is too great, the annular magnet 4261 can easily shift relative to the annular magnetic conduction plate 4264 in the radial direction, thereby resulting in the eccentricity of the transducer 42 that would adversely affect its vibration performance. If the difference is too small, the annular magnet 4261 cannot be effectively positioned using the annular magnetic conduction plate 4264 as reference, increasing the assembly difficulty of the transducer 42.

Therefore, by setting the difference between the outer diameter R1 of the annular magnetic conduction plate 4264 and the outer diameter R2 of the annular magnet 4261 within the reasonable difference range, the outer diameter R1 of the annular magnetic conduction plate 4264 can exceed the outer diameter R2 of the annular magnet 4261, so that the accuracy of the annular magnetic conduction plate 4264 is higher than the accuracy of the annular magnet 4261, thereby improving the positioning accuracy of the annular magnet 4261, and reducing the sizes of the annular magnet 4261 and the annular magnetic conduction plate 4264 in the radial direction of the magnetic circuit system 426 to reduce the size of the transducer 42.

In some embodiments, the ratio of the difference between the inner diameter r2 of the annular magnet 4261 and the inner diameter r1 of the annular magnetic conduction plate 4264 to the radial width of the annular magnet 4261 may be within a range from 0.003 to 0.009. That is, (r2−r1)/(R2−r2)=0.003-0.009.

For example, the ratio of the difference between the inner diameter r2 of the annular magnet 4261 and the inner diameter r1 of the annular magnetic conduction plate 4264 to the radial width of the annular magnet 4261 may be 0.004, 0.006, 0.008, etc.

Specifically, the difference between the inner diameter r2 of the annular magnet 4261 and the inner diameter r1 of the annular magnetic conduction plate 4264 is a distance that an edge of the inner diameter r1 of the annular magnetic conduction plate 4264 extends beyond the inner diameter r2 of the annular magnet 4261. That is, the distance is the difference obtained by subtracting r1 from r2.

If the ratio of the difference between the inner diameter r2 of the annular magnet 4261 and the inner diameter r1 of the annular magnetic conduction plate 4264 to the radial width of the annular magnet 4261 is too great, the size of the annular magnet 4261 in the radial direction can be too small, thereby reducing the magnetic field strength of the annular magnet 4261, and resulting in that the annular magnet 4261 is prone to generate a great displacement in the radial direction. If the ratio of the difference between the inner diameter r2 of the annular magnet 4261 and the inner diameter r1 of the annular magnetic conduction plate 4264 to the radial width of the annular magnet 4261 is too small, it is difficult for the annular magnet 4261 to be correspondingly assembled with the annular magnetic conduction plate 4264.

Therefore, by setting the ratio of the difference between the inner diameter r2 of the annular magnet 4261 and the inner diameter r1 of the annular magnetic conduction plate 4264 to the radial width of the annular magnet 4261 within the reasonable range, the positioning accuracy between the annular magnet 4261 and the annular magnetic conduction plate 4264 can be improved to further fix the position of the annular magnet 4261 in the transducer 42. At the same time, the movement amplitude of the annular magnet 4261 in the radial direction can be reduced, thereby ensuring the magnetic field strength of the annular magnet 4261.

In some embodiments, the difference between the inner diameter r2 of the annular magnet 4261 and the inner diameter r1 of the annular magnetic conduction plate 4264 may be within a range from 0.02 mm to 0.08 mm. For example, the difference between the inner diameter r2 of the annular magnet 4261 and the inner diameter r1 of the annular magnetic conduction plate 4264 may be 0.03 mm, 0.05 mm, 0.07 mm, etc.

Similarly, if the difference between the inner diameter r2 of the annular magnet 4261 and the inner diameter r1 of the annular magnetic conduction plate 4264 is too great, the annular magnet 4261 in the radial direction is too small, thereby reducing the magnetic field strength of the annular magnet 4261. Further, the annular magnet 4261 is prone to generate the great displacement in the radial direction, thereby causing the vibration of the transducer 42 to be unstable. If the difference between the inner diameter r2 of the annular magnet 4261 and the inner diameter r1 of the annular magnetic conduction plate 4264 is too small, it is difficult for the annular magnet 4261 to be correspondingly assembled with the annular magnetic conduction plate 4264.

Therefore, by setting the difference between the inner diameter r2 of the annular magnet 4261 and the inner diameter r1 of the annular magnetic conduction plate 4264 within the reasonable range, the accuracy of the annular magnetic conduction plate 4264 can be higher than the accuracy of the annular magnet 4261, thereby improving the positioning accuracy of the annular magnet 4261. Therefore, the assembly of the annular magnet 4261 can be facilitated. In this way, the magnetic field strength of the annular magnet 4261 can be ensured, and the annular magnet 4261 is not prone to generate the great displacement in the radial direction, thereby causing the vibration effect of the transducer 42, and reducing the size of the annular magnet 4261 in the radial direction of the magnetic circuit system 426 to reduce the size of the transducer 42.

In some embodiments, an axial thickness Hd3 of the annular magnetic conduction plate 4264 may be smaller than an axial thickness Hd2 of the annular magnet 4261. As shown in FIG. 23, the axial thickness Hd3 of the annular magnetic conduction plate 4264 may be indicated by the thickness Hd3 as shown in FIG. 23, and the axial thickness Hd2 of the annular magnet 4261 may be indicated by the thickness Hd2 as shown in FIG. 23. Hd3 is smaller than Hd2.

The annular magnet 4261 primarily functions as an element for generating the magnetic field, and its axial thickness Hd2 of the annular magnet 4261 needs to meet specific requirements to ensure that the annular magnet 4261 can generate the corresponding vibration signals. In contrast, the annular magnetic conduction plate 4264 mainly serves to improve the positioning accuracy of the annular magnet 4261 for easier installation. By designing the axial thickness Hd3 of the annular magnetic conduction plate 4264 to be smaller than the thickness of the annular magnet 4261, the annular magnetic conduction plate 4264 is less likely to interfere with the magnetic field of the annular magnet 4261, thereby further ensuring the vibration effect of the transducer 42.

In addition, by setting a relatively small axial thickness Hd3 of the annular magnetic conduction plate 4264, the size of the transducer 42 in the axial direction Ax2 can also be reduced, and the positioning accuracy of the annular magnet 4261 can be improved for easy and precise installation of the annular magnet 4261.

In some embodiments, as shown in FIG. 19, the annular magnets 4261 includes a first annular magnet 4262 and a second annular magnet 4263. The annular magnetic conduction plate 4264 includes a first annular magnetic conduction plate 4265, a second annular magnet plate 4266, and a third annular magnet plate 4267.

The first annular magnetic conduction plate 4265 may be sandwiched between the first annular magnet 4262 and the second annular magnet 4263 along the axial direction Ax2, the second annular magnetic conduction plate 4266 may be disposed on an outer end surface of the first annular magnet 4262 away from the second annular magnet 4263, and the third annular magnetic conduction plate 4267 may be disposed on an outer end surface of the second annular magnet 4263 away from the first annular magnet 4262.

The first annular magnet 4262 and the second annular magnet 4263 may be two magnets of repelling polarities. The first annular magnet 4262 and the second annular magnet 4263 of repelling polarities may cause magnetic induction lines to be concentrated in the magnetic gap between the first annular magnet 4262 and the second annular magnet 4263, thereby improving the magnetic field effect of the magnetic gap, and improving a sensitivity of the magnetic circuit system 426.

Since the magnetic fields of the first annular magnet 4262 and the second annular magnet 4263 can drive the first annular magnet 4262 and the second annular magnet 4263 to move under an action of the electric field when the transducer 42 is energized, the first magnetic conduction plate 4265, the second magnetic conduction plate 4266, and the third annular magnetic conduction plate 4267 may restrain the magnetic fields of the first annular magnet 4262 and the second annular magnet 4263, so as to converge the magnetic fields to increase an interaction between the magnetic fields and the electric field, thereby increasing the vibration effect of the transducer 42. By disposing the first annular magnet 4262 between the second annular magnet 4263 and the first annular magnetic conduction plate 4265, the second annular magnet 4263 and the first annular magnetic conduction plate 4265 can more accurately position and fix the first annular magnet 4262 in the axial direction Ax2. By disposing the second annular magnet 4263 between the third annular magnetic conduction plate 4267 and the first annular magnetic conduction plate 4265, the third annular magnetic conduction plate 4267 and the first annular magnetic conduction plate 4265 can more accurately position and fix the second annular magnet 4263 in the axial direction Ax2.

In some embodiments, as shown in FIG. 17 and FIG. 19, the coil 422 is overlapped with the first annular magnetic conduction plate 4265 along the axial direction Ax2.

Specifically, the coil 422 corresponds to the annular magnet 4261 in the radial direction. The coil 422 may be energized to enable the electrical signals with the audio information to pass through the coil 422, and the electric field generated by the coil 422 may act on the magnetic field of the annular magnet 4261, thereby driving the annular magnet 4261 and the coil 422 to move relative to each other. Since the annular magnet 4261 is fixed to the annular magnetic conduction plate 4264, the annular magnet 4261 can drive the annular magnetic conduction plate 4264 to vibrate together.

Optionally, as shown in FIG. 17 and FIG. 19, the outer annular fixing portion 4242 is connected to the outer end surface of the second annular magnetic conduction plate 4266 or the outer end surface of the third annular magnetic conduction plate 4267, and the inner annular fixing portion 4241 is connected to the outer end surface of the magnetic conduction cover 423. The vibration transmission sheet 424 is connected to the second annular magnetic conduction plate 4266 or the third annular magnetic conduction plate 4267 through the outer annular fixing portion 4242, and is further connected to the first annular magnetic conduction plate 4267 or the first annular magnet 4262 through the second annular magnetic conduction plate 4266 or the third annular magnetic conduction plate 4267.

Optionally, the vibration transmission sheet 424 may be a magnetic conductor, so as to confine the magnetic field of the transducer 42, thereby converging the magnetic fields toward the coil 422, and improving the magnetic strength at the coil 422 to increase the vibration effect of the transducer 42. By disposing the coil 422 in the middle of the magnetic flux path, the electric field generated by the coil 422 interacts with the magnetic flux path when the coil 422 is energized, so that the coil 422 and the magnetic circuit system 426 move relative to each other to cause the transducer 42 to realize the conversion between electrical energy and the mechanical vibrations.

When the magnetic circuit system 426 and the coil 422 stop vibrating, the at least two elastic connection portions 4243 may also elastically restore to the inner annular fixing portion 4241, so that the support 421 and the magnetic conduction cover 423 can return to an original position opposite to the magnetic circuit system 426.

Optionally, a count of the elastic connection portions 4243 may be four, and the four elastic connection portions 4243 may make the force on the vibration transmission sheet 424 more uniform, thereby improving the structural stability of the vibration transmission sheet 424.

In some embodiments, as shown in FIG. 17 and FIG. 19, the clamp 427 may be disposed to clamp the outer end surfaces of the second annular magnetic conduction plate 4266 and the third annular magnetic conduction plate 4267 along the axial direction Ax2.

As shown in FIG. 2, in some embodiments, the speaker assembly 3 may further include the air conduction speaker 50. The air conduction speaker 50 may convert the electrical signals containing the relevant audio information into the sound wave signals.

Specifically, the air conduction speaker 50 is configured to provide an air conduction sound in a first frequency band, and the bone conduction speaker 40 is configured to provide a bone conduction sound in a second frequency band. At least a portion of the second frequency band is higher than the first frequency band. In other words, the air conduction speaker 50 is configured to provide the sounds in the lower frequency band and the bone conduction speaker 40 is configured to provide the sounds in the higher frequency band. In this way, a sound speaker effect of the speaker assembly 3 can be strengthened, thereby making the low-frequency sound and the high-frequency sound clearer.

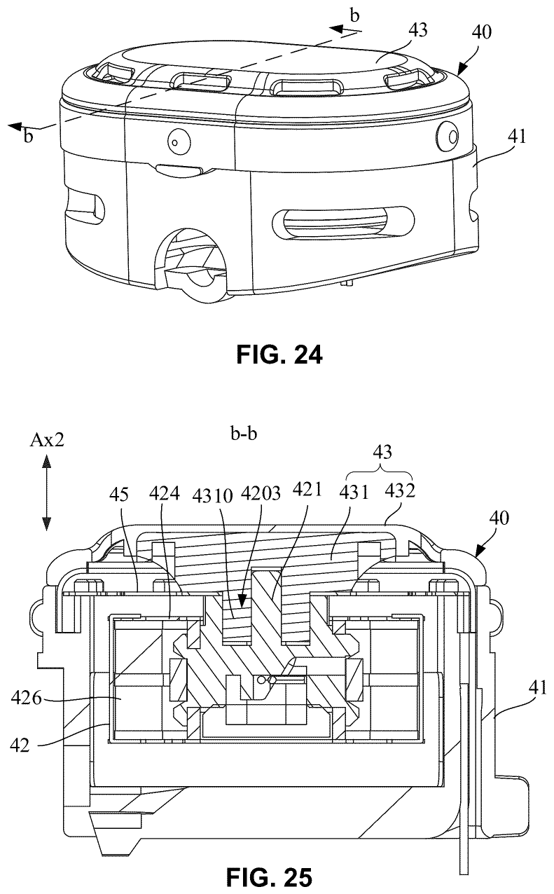

In some embodiments, as shown in FIG. 24 and FIG. 25, the bone conduction speaker 40 includes the core housing 41, the first vibration transmission sheet 45, and the transducer 42. The first vibration transmission sheet 45 connects the core housing 41 and the transducer 42 to suspend the transducer 42 within the core housing 41.

The transducer 42 is the main device in the bone conduction speaker 40 for converting the electrical signals into the vibration signals. The transducer 42 may be disposed inside the core housing 41, and the core housing 41 may relatively fix the transducer 42. The first vibration transmission sheet 45 is configured to be confined to vibrate within the core housing 41 when the transducer 42 is mechanically vibrating, so that the transducer 42 is less likely to fall out of the core housing 41.

In some embodiments, as shown in FIG. 25, the transducer 42 may further include the support 421, the coil 422, the magnetic circuit system 426, and the second vibration transmission sheet 424. The second vibration transmission sheet 424 connects the magnetic circuit system 426 and the support 421 to elastically suspend the magnetic circuit system 426 at the periphery of the support 421. The coil 422 is disposed on the support 421 and within the magnetic circuit system 426.

Optionally, the first vibration transmission sheet 45 may be a non-magnetic conductor and the second vibration transmission sheet 424 may be a magnetic conductor. A material of the first vibration transmission sheet 45 may be, for example, a non-magnetic metal material such as a stainless steel material, a copper material, and/or a non-metallic material that satisfies the corresponding requirements. The second vibration transmission sheet 424 may be a metal material with the magnetic conductivity. For example, the second vibration transmission sheet 424 may be a material including metallic elements, such as, iron, cobalt, nickel, etc.

The first vibration transmission sheet 45 primarily functions as fix the transducer 42 within the core housing 41, by disposing the first vibration transmission sheet 45 as the non-magnetic conductor, the first vibration transmission sheet 45 can be less likely to attract the magnetic circuit system 426 to generate the eccentricity, thus reducing an influence of the first vibration transmission sheet 45 on the vibration effect of the transducer 42. The first vibration transmission sheet 45, due to its elasticity, can suspend the transducer 42 within the core housing 41, thereby reducing the vibrations generated by the transducer 42 to be transmitted to the core housing 41. Therefore, the vibrations generated by the core housing 41 and the sound leakage can be reduced.

By disposing the first vibration transmission sheet 45 as the non-magnetic conductor, the position of the transducer 42 can be more stable without the eccentricity, which in turn makes the transducer 42 operate more stably and generate more stable vibrations. On this basis, by disposing the second vibration transmission sheet 424 as the magnetic conductor, the second vibration transmission sheet 424 can constrain the magnetic field in the transducer 42, thereby converging the magnetic field toward the coil 422. Therefore, the magnetic field strength at the coil 422 can be improved, thereby improving the vibration effect of the energy transducer 42.

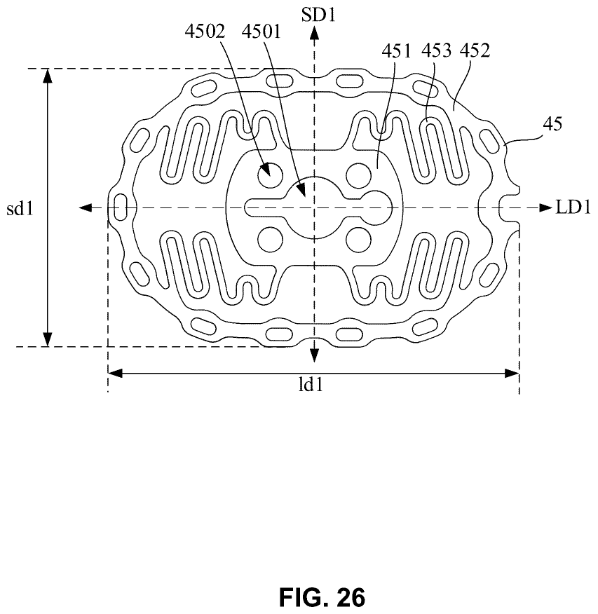

In some embodiments, as shown in FIG. 26, the first vibration transmission sheet 45 may have the long-axis direction LD1 and the short-axis direction SD1 perpendicular to each other, and a size of the first vibration transmission sheet 45 along the long-axis direction LD1 may be greater than a size of the first vibration transmission sheet 45 along the short-axis direction SD1. An elasticity coefficient of the first vibration transmission sheet 45 along the long-axis direction LD1 may be greater than 15,000 Newtons per meter (N/m), and/or an elasticity coefficient of the first vibration transmission sheet 45 along the short-axis direction SD2 may be greater than 6,500 N/m.

Optionally, the elasticity coefficient of the first vibration transmission sheet 45 may be determined according to the Hooke's law of the material. For example, when measuring the elasticity coefficient of the first vibration transmission sheet 45 along the long-axis direction LD1, one end of the first vibration transmission sheet 45 along the long-axis direction LD1 may be fixed, and a weight may be hung on the other end of the first vibration transmission sheet 45 along the long-axis direction LD1. After the deformation of the first vibration transmission sheet 45 along the long-axis direction LD1 is stabilized, a displacement of the end with the weight is measured, and then the elasticity coefficient of the first vibration transmission sheet 45 along the long-axis direction LD1 is determined based on a mass of the weight and the displacement of the end of the first vibration transmission sheet 45 with the weight. The elasticity coefficient of the first vibration transmission sheet 45 along the short-axis direction SD2 may also be determined by referring to the above measurement manner.

The long-axis direction LD1 of the first vibration transmission sheet 45 may be indicated by a direction of an arrow LD1 as shown in FIG. 26, and the size of the first vibration transmission sheet 45 along the long-axis direction LD1 may be indicated by a length LD1 as shown in FIG. 26. The short-axis direction SD1 of the first transmission vibrator 45 may be indicated by a direction of an arrow SD1 as shown in FIG. 26, and the size of the first transmission vibrator 45 along the short-axis direction SD1 may be indicated by a length sd1 as shown in FIG. 26.

If the elasticity coefficients along the long-axis direction LD1 and the short-axis direction SD1 are too small, the first vibration transmission sheet 45 is prone to deform in the long-axis direction LD1 and/or the short-axis direction SD1, resulting in the position of the transducer 42 being distorted and the vibration being unstable. As a result, the bone conduction speaker 40 is prone to generate noise. By setting the elasticity coefficient of the first vibration transmission sheet 45 along the long-axis direction LD1 and/or the elasticity coefficient of the first vibration transmission sheet 45 along the short-axis direction SD1 within the above numerical value ranges, the first vibration transmission sheet 45 may have a greater hardness in the long-axis direction LD1 and/or the short-axis direction SD1, so that the first vibration transmission sheet 45 is less prone to deform in the corresponding directions, thereby reducing the occurrence of transverse deformations of the first vibration transmission sheet 45 due to the vibrations of the transducer 42. Therefore, the noise generated by the speaker assembly 3 due to the vibrations of the first vibration transmission sheet 45 can be reduced, and the occurrence of a positional distortion of the transducer 42 can be reduced, thereby ensuring the vibration effect of the bone conduction speaker 40, and improving the structural stability of the bone conduction speaker 40.

For example, the elasticity coefficient of the first vibration transmission sheet 45 along the long-axis direction LD1 may be disposed to 20000 N/m, 25000 N/m, 30000 N/m. Optionally, the elasticity coefficient of the first vibration transmission sheet 45 along the short-axis direction SD2 may be set to 6500 N/m, 7000 N/m, 8000 N/m.

In some embodiments, as shown in FIG. 26, the first vibration transmission sheet 45 may include a first inner annular fixing portion 451, a first outer annular fixing portion 452, and at least two first elastic connection portions 453. The first outer annular fixing portion 452 may be disposed around a periphery of the first inner annular fixing portion 451, the at least two first elastic connection portions 453 are connected between the first inner annular fixing portion 451 and the first outer annular fixing portion 452, the first outer annular fixing portion 452 is assembled to the core housing 41 via a plug connection, and the first inner annular fixing portion 451 is assembled to the support 421 via a plug connection.

When the transducer 42 mechanically vibrates relative to the core housing 41, the support 421 drives the first inner annular fixing portion 451 to vibrate. When the first inner annular fixing portion 451 vibrates, the first inner annular fixing portion 451 drives the at least two first elastic connection portions 453 to undergo elastic deformation, and the at least two first elastic connection portions 453 may confine the transducer 42 within the core housing 41. When the transducer 42 stops vibrating, the at least two first elastic connection portions 453 may return the transducer 42 to the original position of the transducer 42 by restoring the first inner annular fixing portion 451.

Furthermore, by assembling the first outer annular fixing portion 452 and the core housing 41 in the plug connection and assembling the first inner annular fixing portion 451 and the support 421 in the plug connection, the installation of the first vibration transmission sheet 45 is facilitated, thereby simplifying the installation of the speaker assembly 3, improving the assembly efficiency, and reducing the assembly difficulty of the speaker assembly 3.

For example, in some embodiments, a count of the first elastic connection portion 453 may be four. The four first elastic connection portions 453 may be disposed in the first outer annular fixing portion 452 and the first inner annular fixing portion 451 in a uniform manner. When the first inner annular fixing portion 451 is driven to displace, the four first elastic connection portions 453 may elastically deform together to limit the first inner annular fixing portion 451, so as to make the force on the first inner annular fixing portion 451 and the first outer annular fixing portion 452 more uniform, thereby improving the structural stability of the first vibration transmission sheet 45.

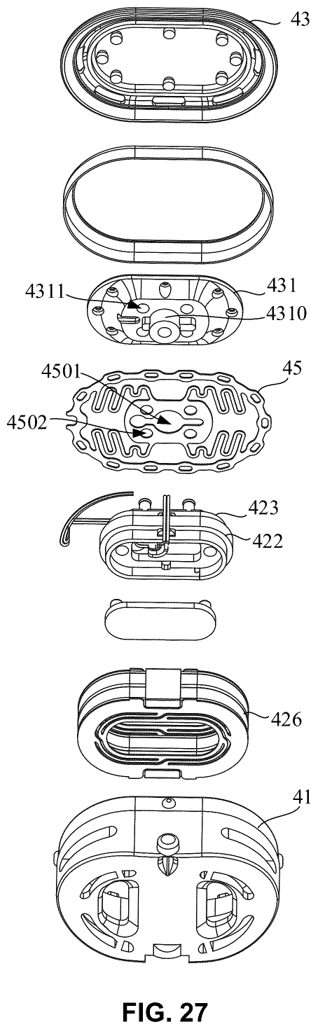

In some embodiments, as shown in FIGS. 25-27, the bone conduction speaker 40 further includes the vibration plate 431. The support 421 may be provided with the first plugging hole 4203 and the plurality of first plugging posts 4204 on the side of the support 421 facing the first inner annular fixing portion 451. The plurality of first plugging posts 4204 are disposed around the periphery of the first plugging hole 4203 and spaced apart from each other. The first inner annular fixing portion 451 may be provided with the exposed hole 4501 and the plurality of assembly holes 4502. The plurality of assembly holes 4502 are disposed around the periphery of the exposed hole 4501 and spaced apart from each other.

The vibration plate 431 may be provided with the second plugging post 4310 and the plurality of second plugging holes 4311. The plurality of second plugging holes 4311 are disposed around the periphery of the second plugging post 4310 and spaced apart from each other. The second plugging post 4310 is plugged into the first plugging hole 4203, and the plurality of first plugging posts 4204 are plugged into the plurality of second plugging holes 4311, respectively.

The vibration plate 431 and the support 421 may further fix the first inner annular fixing portion 451 between the vibration plate 431 and the support 421 via a plug connection, thereby improving the assembling efficiency, so as to enable the first vibration transmission sheet 45 to achieve a stronger connection with the transducer 42, thereby further improving the structural stability of the bone conduction speaker 40.

Further, during the mechanical vibrations of the transducer 42, the transducer 42 may drive the vibration plate 431 to vibrate, thereby transmitting the vibration signals to a human body through the vibration plate 431.

Further, as shown in FIGS. 17-19, the second vibration transmission sheet 424 may include a second inner annular fixing portion 4241, a second outer annular fixing portion 4242, and at least two second outer elastic connection portions 4243. The second outer annular fixing portion 4242 is disposed around a periphery of the second inner annular fixing portion 4241, and the at least two second outer elastic connection portions 4243 are connected between the second inner annular fixing portion 4241 and the second outer annular fixing portion 4242. The second outer annular fixing portion 4242 is connected to the outer end surface of the magnetic circuit system 426, and the second inner annular fixing portion 4241 is connected to the outer end surface of the magnetic conduction cover 423.

In some embodiments, as shown in FIG. 19, the second inner annular fixing portion 4241 may be welded and fixed to the outer end surface of the magnetic conduction cover 423, and the second outer annular fixing portion 4242 may be welded and fixed to the outer end surface of the magnetic circuit system 426. By using the welding connection, the second vibration transmission sheet 424 can be installed on the outer end surface of the magnetic circuit system 426 and the outer end surface of the magnetic conduction cover 423, thereby simplifying the assembly process of the transducer 42. The welding connection can strengthen the connection strength between the second vibration transmission sheet 424 and the magnetic circuit system 426 and the connection strength between the second vibration transmission sheet 424 and the magnetic conduction cover 423, thereby making the structure of the transducer 42 more robust and stable.

In some embodiments, a coverage degree of the second outer annular fixing portion 4242 on the outer end surface of the magnetic system 426 may be greater than or equal to 60%, and/or a coverage degree of the second inner annular fixing portion 4241 on the outer end surface of the magnetic conduction cover 423 is greater than or equal to 60%.

The outer end surface of the magnetic circuit system 426 refers to an end surface of the magnetic circuit system 426 along the axial direction Ax2, and the outer end surface of the magnetic circuit system 426 may be perpendicular to the axial direction Ax2 of the transducer 42.

Specifically, the coverage degree of the second outer annular fixing portion 4242 on the outer end surface of the magnetic circuit system 426 may be an overlapping portion of the second outer annular fixing portion 4242 to the outer end surface of the magnetic circuit system 426 along the axial direction Ax2 of the transducer 42. The coverage degree of the second inner annular fixing portion 4241 on the outer end surface of the magnetic conduction cover 423 may also be an overlapping portion of the second inner annular fixing portion 4241 to the outer end surface of the magnetic conduction cover 423 along the axial direction Ax2 of the transducer 42.

For example, the coverage degree of the second outer annular fixing portion 4242 on the outer end surface of the magnetic circuit system 426 may specifically be 70%, 80%, 90%. Optionally, the coverage degree of the second inner annular fixing portion 4241 on the outer end surface of the magnetic conduction cover 423 may be specifically 70%, 80%, 90%.

If the coverage degree of the second outer annular fixing portion 4242 on the outer end surface of the magnetic circuit system 426 is too small, the fixing of the second outer annular fixing portion 4242 and the magnetic circuit system 426 can be unstable, thereby reducing the magnetic effect of the second vibration transmission sheet 424 and an effect on improving the magnetic field strength of the magnetic gap. Therefore, by disposing the coverage degree of the second outer annular fixing portion 4242 on the outer end surface of the magnetic circuit system 426 within the above values, the fixing effect of the second outer annular fixing portion 4242 and the magnetic circuit system 426 can be ensured, and the magnetic conduction effect of the second vibration transmission sheet 424 can be strengthened, thereby improving the magnetic field strength of the magnetic gap.

If the coverage degree of the second inner annular fixing portion 4241 on the outer end surface of the magnetic conduction cover 423 is too small, the fixing effect of the second inner annular fixing portion 4241 and the outer end surface of the magnetic conduction cover 423 can be poor, thereby reducing the constrain effect of the magnetic field of the second vibration transmission sheet 424. Therefore, by disposing the coverage degree of the second outer annular fixing portion 4242 on the outer end surface of the magnetic circuit system 426 within the above values, the connection between the second vibration transmission sheet 424 and the magnetic circuit system 426 and the connection between the second vibration transmission sheet 424 and the magnetic conduction cover 423 can be strengthened, so that the second vibration transmission sheet 424 is less likely to disengage from the magnetic circuit system 426 and the magnetic conduction cover 423 during the movement, thereby improving the structural stability of the bone conduction speaker 40 and the constrain effect of the magnetic field.

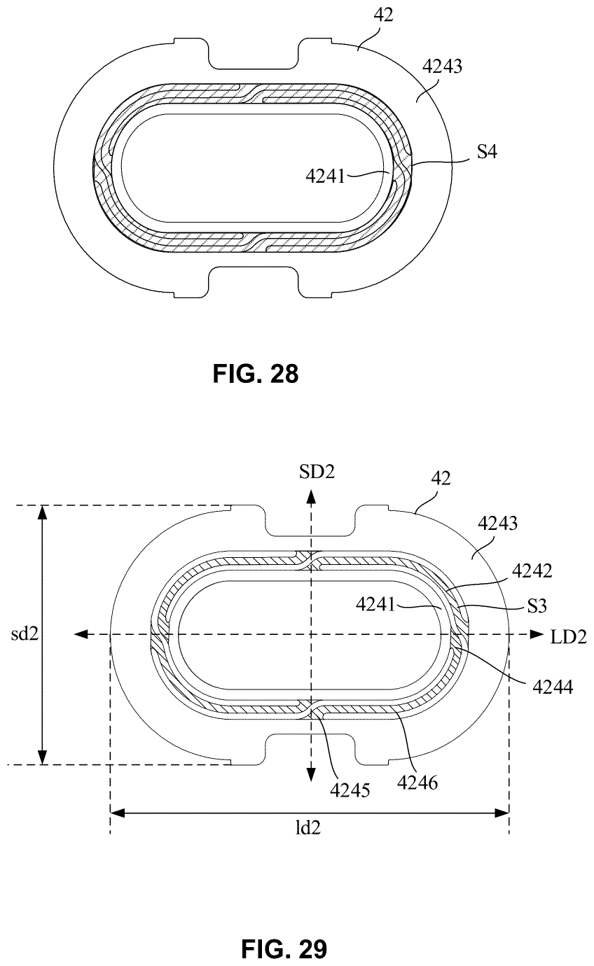

In some embodiments, as shown in FIG. 28 and FIG. 29, when viewed along the vibration direction of the transducer 42, the at least two second outer elastic connection portions 4243 may have a first area S3, and an annular region between the outer edge of the second inner annular fixing portion 4241 and the inner edge of the second outer annular fixing portion 4242 may have a second area S4. A ratio of the first area S3 to the second area S4 may be within a range from 0.2 to 0.7.

The first area S3 may be indicated by the shaded portion as shown in FIG. 29 and the second area S4 may be indicated by the shaded portion as shown in FIG. 28.

Specifically, the at least two second outer elastic connection portions 4243 are disposed within the annular region between the outer edge of the second inner annular fixing portion 4241 and the inner edge of the second outer annular fixing portion 4242. The ratio of the first area S3 to the second area S4 may also characterize a ratio of an are of the at least two second outer elastic connection portions 4243 to the area of the annular region.

If the area of the first region S3 is too great such that the ratio of the first area S3 to the second area S4 is too great, an elasticity of the at least two second outer elastic connection portions 4243 can be reduced, thereby affecting the vibration effect of the transducer 42. If the area of the first area S3 is too small such that the ratio of the first area S3 to the second area S4 is too small, the converging effect of the magnetic fields of the at least two second outer elastic connection portions 4243 is affected, thereby reducing the constrain effect on the magnetic field of the vibration transmission sheet 424.

Thus, by setting the ratio of the area of the at least two second outer elastic connection portions 4243 to the area of the annular region within the range from 0.2 to 0.7, the at least two second outer elastic connection portions 4243 can provide proper magnetic field concentration effects for constraining and focusing the magnetic field. At the same time, by limiting the area of the at least two second outer elastic connection portions 4243, the elasticity of the at least two second outer elastic connection portions 4243 can be further limited, so that the at least two second outer elastic connection portions 4243 do not exhibit excessive elasticity that could adversely affect the vibration effect of the transducer 42.

For example, the first area S3 of the at least two second outer elastic connection portions 4243 may be 12.5, 14, or 15.5 square millimeters, and the second area S4 of the annular region between the outer edge of the second inner annular fixing portion 4241 and the inner edge of the second outer fixing portion 4242 may be 33.5, 35, or 36.5 square millimeters. The ratio of the first area S3 to the second area S4 may be 0.4.

In other embodiments, the ratio of the first area S3 to the second area S4 may be 0.3, 0.5, 0.6, etc.

In some embodiments, as shown in FIG. 29, the second outer elastic connection portion 4243 may include a first connection portion 4244, a second connection portion 4245, and an elastic portion 4246, respectively. The first connection portion 4244 may be connected to the outer edge of the second inner annular fixing portion 4241, the second connection portion 4245 may be connected to the inner edge of the second outer annular fixing portion 4242, and the elastic portion 4246 is disposed between the first connection portion 4244 and the second connection portion 4245. The elastic portion 4246 may be spaced apart from each of the outer edge of the second inner annular fixing portion 4241 and the inner edge of the second outer annular fixing portion 4242, respectively, and a space distance is within a range from 0.1 mm to 0.4 mm. For example, the space distance may be 0.17 mm, 0.26 mm, 0.29 mm, 0.35 mm, etc. In a plane perpendicular to the axial direction Ax2, a width of the elastic portion 4246 may be a value of 0.28 mm, 0.34 mm, 0.41 mm, etc.

Specifically, during the elastic movement of the second outer elastic connection portion 4243, the elastic portion 4246 is a main region where the elastic deformation occurs. The space distance between the elastic portion 4246 and each of the outer edge of the second inner annular fixing portion 4241 and the inner edge of the second outer annular fixing portion 4242 affects a size of the elastic portion 4246. Thus, by disposing the space distance within the range from 0.1 mm and 0.4 mm, the elastic portion 4246 can have a greater size so as to efficiently converge the magnetic field, and the elastic portion 4246 can not easily contact the second inner annular fixing portion 4241 and the second outer annular fixing portion 4242. In particular, when the elastic portion 4246 undergoes the elastic deformation and drives the second inner annular fixing portion 4241 to vibrate, the elastic portion 4246 is not easily interfered with the second inner annular fixing portion 4241 and the second outer annular fixing portion 4242, thereby ensuring the vibration effect of the transducer 42.

In some embodiments, as shown in FIG. 29, the second vibration transmission sheet 424 may have a long-axis direction LD2 and a short-axis direction SD2. A size of the second vibration transmission sheet 424 along the long-axis direction LD2 is greater than a size of the second vibration transmission sheet 424 along the short-axis direction SD2. An elasticity coefficient of the second vibration transmission sheet 424 along the long-axis direction LD2 is greater than or equal to 55,000 N/m, and/or an elasticity coefficient of the second vibration transmission sheet 424 along the short-axis direction SD2 is greater than or equal to 9,500 N/m.

The long-axis direction LD2 of the second vibration transmission sheet 424 may be indicated by a direction of an arrow LD2 as shown in FIG. 29, and the size of the second vibration transmission sheet 424 along the long-axis direction LD2 may be indicated by a length ld2 as shown in FIG. 29. The short-axis direction SD2 of the second transmission vibrator 424 may be indicated by a direction of an arrow SD2 as shown in FIG. 29, and the size of the second transmission vibrator 424 along the short-axis direction SD2 may be indicated by a length sd2 as shown in FIG. 29.

Specifically, if the elastic coefficients of the second vibration transmission sheet 424 along the long-axis direction LD2 and the short-axis direction SD2 are too small, the second vibration transmission sheet 424 is prone to deform during the vibration of the transducer 42, resulting in the misalignment of the transducer 42 and unstable vibration. Therefore, the bone conduction speaker 40 is prone to generate the noise. Therefore, by disposing the elasticity coefficient of the second vibration

transmission sheet 424 along the long-axis direction LD2 greater than or equal to 55,000 N/m, and disposing the elasticity coefficient of the second vibration transmission sheet 424 along the short-axis direction SD2 greater than or equal to 9,500 N/m, the second vibration transmission sheet 424 can have a certain hardness to separate the magnetic conduction cover 423 from the magnetic circuit system 426, thereby preventing the magnetic conduction cover 423 from adhering to the magnetic circuit system 426. At the same time, by disposing the elasticity coefficients of the second vibration transmission sheet 424 in the long-axis direction LD2 and in the short-axis direction SD2 greater, the elastic portion 4246 of the second vibration transmission sheet 424 can be less likely to break or deform when the second vibration transmission sheet 424 vibrates due to a great vibration intensity, thereby improving the reliability and structural stability of the second vibration transmission sheet 424 and ensuring the vibration effect of the transducer 42.

For example, the elasticity coefficient of the second vibration transmission sheet 424 along the long-axis direction LD2 may be disposed to 60,000 N/m, 70,000 N/m, 80,000 N/m, etc. Optionally, the elasticity coefficient of the second vibration transmission sheet 424 along the short-axis direction SD2 may be disposed to 10,000 N/m, 20,000 N/m, 25,000 N/m, etc.

In some embodiments, as shown in FIG. 2 and FIG. 25, the bone conduction speaker 40 may also include the vibration transmission facial contact assembly 43 and the auxiliary facial contact assembly 44.

The vibration transmission facial contact assembly 43 may include the vibration plate 431 and the soft vibration transmission member 432. The vibration plate 431 is connected to the transducer 42, and the soft vibration transmission member 432 may be disposed on the vibration plate 431. When the transducer 42 is vibrating, the support 421 in the transducer 42 may further drive the vibration plate 431 to vibrate, and the vibration plate 431 may further drive the soft vibration transmission member 432 to vibrate to generate the vibration signals.

Furthermore, the auxiliary facial contact assembly 44 may also include the hard support member 441 and the soft contact member 442. The hard support member 441 is connected to the core housing 41, the soft contact member 442 is disposed on the hard support member 441, and the soft contact member 442 and the soft vibration transmission member 432 are configured to contact with the facial region anterior to the tragus in the wearing state. Optionally, the hard support member 441 may be connected to the core housing 41, and the soft contact member 442 may be disposed on a side of the hard support member 441 away from the core housing 41.

The hard support member 441 and the soft contact member 442 may define an exposed region of the soft vibration transmission member 432 to enable the soft vibration transmission member 432 to contact the facial region anterior to the tragus in the wearing state, and to transmit the vibration signals to the human body.

The soft contact member 442 and the soft vibration transmission member 432 may contact the facial region anterior to the tragus together to improve a contact area between the speaker assembly 3 and the human face, thereby improving the wearing comfort of the speaker assembly 3.

Optionally, in a natural state, a protruding height Ht2 of the soft contact member 442 relative to the soft vibration transmission member 432 is within a range from 0.4 mm to 1 mm. For example, the protruding height Ht2 of the soft contact member 442 relative to the soft vibration transmission member 432 may be 0.5 mm, 0.6 mm, 0.8 mm.

Optionally, the soft contact member 442 may be softer than the soft vibration transmission member 432, so that the soft contact member 442 can improve the wearing comfort of the speaker assembly 3 and be pressed to be leveled with the soft vibration transmission member 432 to contact together on the human face when the speaker assembly 3 is in the wearing state. Therefore, the soft contact member 442 can share the pressure on the soft vibration transmission member 432, thereby further improving the vibration effect of the soft vibration transmission member 432.

The above descriptions are only a portion of embodiments of the present disclosure, and are not intended to limit the scope of the present disclosure. Any equivalent device or equivalent process transformed using the contents of the specification of the present disclosure and the accompanying drawings, or directly or indirectly applied in other related technical fields, are all included in the scope of the present disclosure.

1-29. (canceled)

30. A speaker assembly, comprising:
a bone conduction speaker, wherein
the bone conduction speaker includes a transducer, a core housing, and a first vibration transmission sheet,
the transducer includes a magnetic circuit system, a support, a coil, and a second vibration transmission sheet,
the first vibration transmission sheet connects the core housing and the transducer to suspend the transducer within the core housing,
the second vibration transmission sheet connects the magnetic circuit system and the support to elastically suspend the magnetic circuit system at a periphery of the support,
the coil is disposed on the support and located within the magnetic circuit system, and
the first vibration transmission sheet is a non-magnetic conductor and the second vibration transmission sheet is a magnetic conductor.

31. The speaker assembly of claim 30, wherein the speaker assembly further includes an air conduction speaker,
the air conduction speaker is configured to provide an air conduction sound in a first frequency band,
the bone conduction speaker is configured to provide a bone conduction sound in a second frequency band, and
at least a portion of the second frequency band is higher than the first frequency band.

32. The speaker assembly of claim 30, wherein the first vibration transmission sheet has a long-axis direction and a short-axis direction perpendicular to each other,
a size of the first vibration transmission sheet along the long-axis direction is greater than a size of the first vibration transmission sheet along the short-axis direction,
an elastic coefficient of the first vibration transmission sheet along the long-axis direction is greater than 15,000 Newtons per meter (N/m), and
an elastic coefficient of the first vibration transmission sheet along the short-axis direction is greater than 6,500 N/m.

33. The speaker assembly of claim 30, wherein the bone conduction speaker further includes a vibration transmission facial contact assembly and an auxiliary facial contact assembly,
the vibration transmission facial contact assembly includes a vibration plate and a soft vibration transmission member,
the vibration plate is connected to the transducer, and the soft vibration transmission member is disposed on the vibration plate, and
the auxiliary facial contact assembly includes a hard support member and a soft contact member,
the hard support member is connected to the core housing, the soft contact member is disposed on the hard support member,
the soft contact member and the soft vibration transmission member are configured to contact with a facial region anterior to a tragus in a wearing state, and
in a natural state, a protruding height of the soft contact member relative to the soft vibration transmission member is within a range from 0.4 mm to 1 mm.

34. The speaker assembly of claim 30, wherein the first vibration transmission sheet includes a first inner annular fixing portion, a first outer annular fixing portion, and at least two first elastic connection portions,
the first outer annular fixing portion is disposed at a periphery of the first inner annular fixing portion,
the at least two first elastic connection portions are connected between the first inner annular fixing portion and the first outer annular fixing portion,
the first outer annular fixing portion is assembled to the core housing via a plug connection, and
the first inner annular fixing portion is assembled to the support via a plug connection.

35. The speaker assembly of claim 34, wherein the bone conduction speaker further includes a vibration plate,
a side of the support facing the first inner annular fixing portion is provided with a first plugging hole and a plurality of first plugging posts, the plurality of first plugging posts being disposed at a periphery of the first plugging hole and spaced apart from each other,
the first inner annular fixing portion is provided with an exposed hole and a plurality of assembly holes, the plurality of assembly holes being disposed at a periphery of the exposed hole and spaced apart from each other,
the first plugging hole is exposed through the exposed hole, and each of the plurality of first plugging posts is inserted into a corresponding assembly hole in the assembly holes,
the vibration plate is provided with a second plugging post and a plurality of second plugging holes, the plurality of second plugging holes being disposed at a periphery of the second plugging post and spaced apart from each other,
the second plugging post is plugged into the first plugging hole, and the plurality of first plugging posts are plugged into the plurality of second plugging holes, respectively.

36. The speaker assembly of claim 30, wherein the transducer further includes a magnetic conduction cover,
the magnetic conduction cover is arranged in a cylindrical shape and connected to the support, and the coil is wound at a periphery of the magnetic conduction cover,
the second vibration transmission sheet includes a second inner annular fixing portion, a second outer annular fixing portion, and at least two second outer elastic connection portions,
the second outer annular fixing portion is disposed at a periphery of the second inner annular fixing portion,
the at least two second outer elastic connection portions are connected between the second outer annular fixing portion and the second inner annular fixing portion,
the second outer annular fixing portion is connected to at least one of the two outer end surfaces of the magnetic circuit system, and
the second inner annular fixing portion is connected to an outer end surface of the magnetic conduction cover.

37. The speaker assembly of claim 36, wherein
a coverage rate of the second outer annular fixing portion over the corresponding outer end surface of the magnetic circuit system is greater than or equal to 60%, and
a coverage rate of the second inner annular fixing portion over the outer end surface of the magnetic conduction cover is greater than or equal to 60%.

38. The speaker assembly of claim 36, wherein when viewed along a vibration direction of the transducer,
each of the at least two second outer elastic connection portions has a first area,
an annular region between an outer edge of the second inner annular fixing portion and an inner edge of the second outer annular fixing portion has a second area, and
a ratio of the first area to the second area is within a range from 0.2 to 0.7.

39. The speaker assembly of claim 38, wherein each of the at least two second outer elastic connection portions includes a first connection portion, a second connection portion, and an elastic portion,
the first connection portion is connected to the outer edge of the second inner annular fixing portion,
the second connection portion is connected to the inner edge of the second outer annular fixing portion,
the elastic portion is disposed between the first connection portion and the second connection portion, and
the elastic portion is spaced apart from each of the outer edge of the second inner annular fixing portion and the inner edge of the second outer annular fixing portion by a space distance, the space distance being within a range from 0.1 mm to 0.4 mm.

40. The speaker assembly of claim 36, wherein the second vibration transmission sheet has a long-axis direction and a short-axis direction,
a size of the second vibration transmission sheet along the long-axis direction is greater than a size of the second vibration transmission sheet along the short-axis direction, and
an elastic coefficient of the second vibration transmission sheet along the long-axis direction is greater than or equal to 55,000 N/m and an elastic coefficient of the second vibration transmission sheet along the short-axis direction is greater than or equal to 9,500 N/m.

41. The speaker assembly of claim 30, wherein
the transducer further includes a clamp, and
the clamp is configured to clamp two outer end surfaces of the magnetic circuit system away from each other along the axial direction.

42. The speaker assembly of claim 41, wherein the clamp includes a first abutment portion, a second abutment portion, and a connection portion,
the first abutment portion abuts against one of the two outer end surfaces of the magnetic circuit system,
the second abutment portion abuts against the other one of the two outer end surfaces of the magnetic circuit system, and
the connection portion is connected between the first abutment portion and the second abutment portion.

43. The speaker assembly of claim 42, wherein the first abutment portion, the second abutment portion, and the connection portion are formed by bending a plate and are disposed in a U-shape.

44. The speaker assembly of claim 42, wherein the second vibration transmission sheet includes an inner annular fixing portion, an outer annular fixing portion, and at least two elastic connection portions,
the outer annular fixing portion is disposed at a periphery of the inner annular fixing portion,
the at least two elastic connection portions are connected between the inner annular fixing portion and the outer annular fixing portion,
the inner annular fixing portion is connected to the support,
the outer annular fixing portion is connected to at least one of the two outer end surfaces of the magnetic circuit system,
the outer annular fixing portion is provided with at least one notch, the at least one of the two outer end surfaces of the magnetic circuit system being exposed from the at least one notch, and
at least one of the first abutment portion or the second abutment portion are disposed to abut against an exposed portion of the at least one of the two outer end surfaces of the magnetic circuit system exposed from the at least one notch.

45. The speaker assembly of claim 44, wherein the at least one notch includes at least two notches,
the at least two notches are disposed at intervals along a circumferential direction of the outer annular fixing portion,
each of the at least two notches is connected to an outer edge of the outer annular fixing portion, and
along the circumferential direction of the outer annular fixing portion, a ratio of a total width of the at least two notches on the outer edge of the outer annular fixing portion to a circumference of the outer edge of the outer annular fixing portion is smaller than or within a range from 0.08 to 0.25.

46. The speaker assembly of claim 30, wherein the magnetic circuit system includes at least two annular magnets and annular magnetic conduction plates that are stacked along an axial direction of the magnetic circuit system,
a first outer diameter of each of the annular magnetic conduction plates is greater than a second outer diameter of each of the at least two annular magnets, and a first inner diameter of each of the annular magnetic conduction plates is smaller than a second inner diameter of each of the at least two annular magnets.

47. The speaker assembly of claim 46, wherein
a ratio of a difference between the first outer diameter and the second outer diameter to a radial width of each of the at least two annular magnets is within a range from 0.002 to 0.007, and
a ratio of a difference between the second inner diameter and the first inner diameter to a radial width of each of the at least two annular magnets is within a range from 0.003 to 0.009.

48. The speaker assembly of claim 46, wherein the at least two annular magnets include a first annular magnet and a second annular magnet, and the annular magnetic conduction plates include a first annular magnetic conduction plate, a second annular magnetic conduction plate, and a third annular magnetic conduction plate,
the first annular magnetic conduction plate is clamped between the first annular magnet and the second annular magnet along the axial direction,
the second annular magnetic conduction plate is disposed on an outer end surface of the first annular magnet away from the second annular magnet,
the third annular magnetic conduction plate is disposed at an outer end surface of the second annular magnet away from the first annular magnet, and
the coil is arranged to overlap with the first annular magnetic conduction plate along the axial direction.

49. An earphone, comprising:
a speaker assembly comprising the bone conduction speaker of claim 30; and
a wearing assembly connected to the speaker assembly, wherein the wearing assembly is configured to position the speaker assembly at a facial region anterior to a user's tragus in a wearing state.
